(19) United States
(12) Patent Application Publication
(10) Pub. No.: US 2013/0185531 A1
(43) Pub. Date: Jul. 18, 2013

(54) METHOD AND APPARATUS TO IMPROVE EFFICIENCY IN THE USE OF HIGH PERFORMANCE STORAGE RESOURCES IN DATA CENTER

(71) Applicants: Hironori EMARU, Santa Clara, CA (US); Shunji Kawamura, Los Gatos, CA (US)

(72) Inventors: Hironori EMARU, Santa Clara, CA (US); Shunji Kawamura, Los Gatos, CA (US)

(73) Assignee: HITACHI, LTD., Tokyo (JP)

(21) Appl. No.: 13/352,115

(22) Filed: Jan. 17, 2012

(51) Int. Cl. G06F 12/02

(52) U.S. Cl. 711/162; 711/154; 711/E12.002

(57) ABSTRACT

Systems and methods described herein are directed to determining a partial migration plan to execute based on a policy. In situations where the performance of the virtual volumes is insufficient, the virtual volume should be migrated to a different storage pool or have high-performance media added to its current storage pool. A management program creates several migration plans for execution, which may include more than one partial migration plans. The plans may indicate the original storage subsystem, the target storage subsystem and a number of pages. The management program selects one of the plans, and proceeds to execute the selected plan.

### BACKGROUND OF THE INVENTION

Virtualization technology utilizing high-performance storage media, such as Solid State Drives (SSD), may be utilized in data centers. In the related art implementation known as dynamic storage tiering, multiple storage media are managed by a small chunk (page) in a storage pool, and suitable storage media are assigned from the storage pool based on a performance requirement.

Virtualization technology may provide many benefits to data centers, such as the user provisioning of virtual resources that exceed the actual physical resources available (i.e. over provisioning) as well as aggregation of storage resources from various systems. In related art implementations, a storage system can use storage resources from a storage subsystem, or lease resources from other storage systems. Thus, virtualization technology allows resources to coexist in one data center in a heterogeneous environment.

Performances of Information Technology (IT) resources can thereby be mixed in one data center. For example, SSD may be used as a new storage media in addition to Hard Disk Drives (HDDs). SSD is a high-performance but expensive media, and may be mixed with HDDs, depending on the requirements of the data center. Therefore, multiple storage media may coexist within a data center utilizing virtualization technology, which creates a variation in performance.

### SUMMARY OF THE INVENTION

Aspects of the exemplary embodiments include a first storage system containing a storage device; and a controller that manages a plurality of virtual volumes and changes a status of one of the plurality of virtual volumes from a first status to a second status. One of the plurality of virtual volumes has a higher load The first status indicates having a plurality of Input/Output (I/O) requests to the one of the plurality of virtual volumes executed by the first storage system. The second status indicates having the plurality of I/O requests to the one of the plurality of virtual volumes executed by the first storage system and a second storage system coupled to the first storage system.

Additional aspects of the exemplary embodiments include a method of a first storage system with a storage device. The method involves managing a plurality of virtual volumes; and changing a status of one of the plurality of virtual volumes from a first status to a second status. One of the plurality of virtual volumes has a higher load. The first status indicates having a plurality of Input/Output (I/O) requests to the one of the plurality of virtual volumes executed by the first storage system. The second status indicates having the plurality of I/O requests to the one of the plurality of virtual volumes executed by the first storage system and a second storage system coupled to the first storage system.

Additional aspects of the exemplary embodiments include a system, which includes a management server, a first storage system containing a storage device; and a controller that manages a plurality of first virtual volumes and changes a status of one of the plurality of first virtual volumes from a first status to a second status; and a second storage system coupled to the first storage system. One of the plurality of first virtual volumes has a higher load. The first status indicates having a plurality of Input/Output (I/O) requests to the one of the plurality of first virtual volumes executed by the first storage system. The second status indicates having the plurality of I/O requests to the one of the plurality of first virtual volumes executed by the first storage system and a second storage system coupled to the first storage system.

### BRIEF DESCRIPTION OF THE DRAWINGS

These, and or/other aspects will become more readily appreciated from the following description of the embodiments, taken in conjunction with the accompanying drawings, in which:

FIG. 1 illustrates a system configuration in accordance with the first exemplary embodiment.

FIG. 2 illustrates a configuration of a management server in accordance with the first exemplary embodiment.

FIG. 3 illustrates a configuration of the server of the data center in accordance with the first exemplary embodiment.

FIG. 4 illustrates an exemplary configuration of a Storage Subsystem, in accordance with the first exemplary embodiment.

FIG. 5 illustrates a logical configuration of the system in accordance with the first exemplary embodiment.

FIG. 6 illustrates a configuration of the media performance table of the management server in accordance with the first exemplary embodiment.

FIG. 7 illustrates a configuration of the Service Level Objective (SLO) management table of the management server in accordance with the first exemplary embodiment.

FIG. 8 illustrates a configuration of the configuration information table of the management server in accordance with the first exemplary embodiment.

FIG. 9 illustrates a configuration of the server configuration information table of the management server in accordance with the first exemplary embodiment.

FIG. 10 illustrates a configuration of the storage configuration information table of the management server in accordance with the first exemplary embodiment.

FIG. 11 illustrates a configuration of the pool configuration table of the storage subsystem in accordance with the first exemplary embodiment.

FIG. 12 illustrates a configuration of the I/O distribution table of the management server, in accordance with the first exemplary embodiment.

FIG. 13 illustrates a configuration of the page mapping table of the server in accordance with the first exemplary embodiment.

FIG. 14 illustrates a configuration of the media assignment table of the storage subsystem in accordance with the first exemplary embodiment.

FIG. 15 illustrates a flowchart of the management program of the management server in accordance with the first exemplary embodiment.

FIG. 16 illustrates a logical configuration of the system in accordance with the first exemplary embodiment.

FIG. 17 and FIG. 18 illustrate media assignment tables in accordance with the second exemplary embodiment.

FIG. 19 illustrates a page distribution graph in accordance with the second exemplary embodiment.

FIG. 20 illustrates the page distribution graph to evaluate the impact of partial migration in accordance with the second exemplary embodiment.

FIG. 21 illustrates a migration plan evaluation table in accordance with the second exemplary embodiment.

FIG. 22 illustrates an exemplary flowchart of the turn back program in the management server in accordance with the fourth exemplary embodiment.

FIG. 23 illustrates an exemplary flowchart of the management program in the management server in accordance with the fifth exemplary embodiment.

### DETAILED DESCRIPTION OF THE INVENTION

Data centers need to ensure that their Service Level Objective (SLO) is met. With virtualization technology, the performance of a virtual volume may be insufficient in view of the SLO. In such a situation, the virtual volume should either be migrated to a different storage pool, or have additional high-performance media added to the storage pool.

Migrating a virtual volume takes time, because the virtual volume is associated with a storage pool containing multiple storage media. Although it may be possible to execute a partial migration, difficulties may arise in determining which and how many pages in the storage pool should be migrated, and a migration destination. The exemplary embodiments described herein are directed to creating one or more partial migration plans to satisfy the SLO.

### First Exemplary Embodiment

The first exemplary embodiment is directed to addressing efficiency of resource usage by the data center.

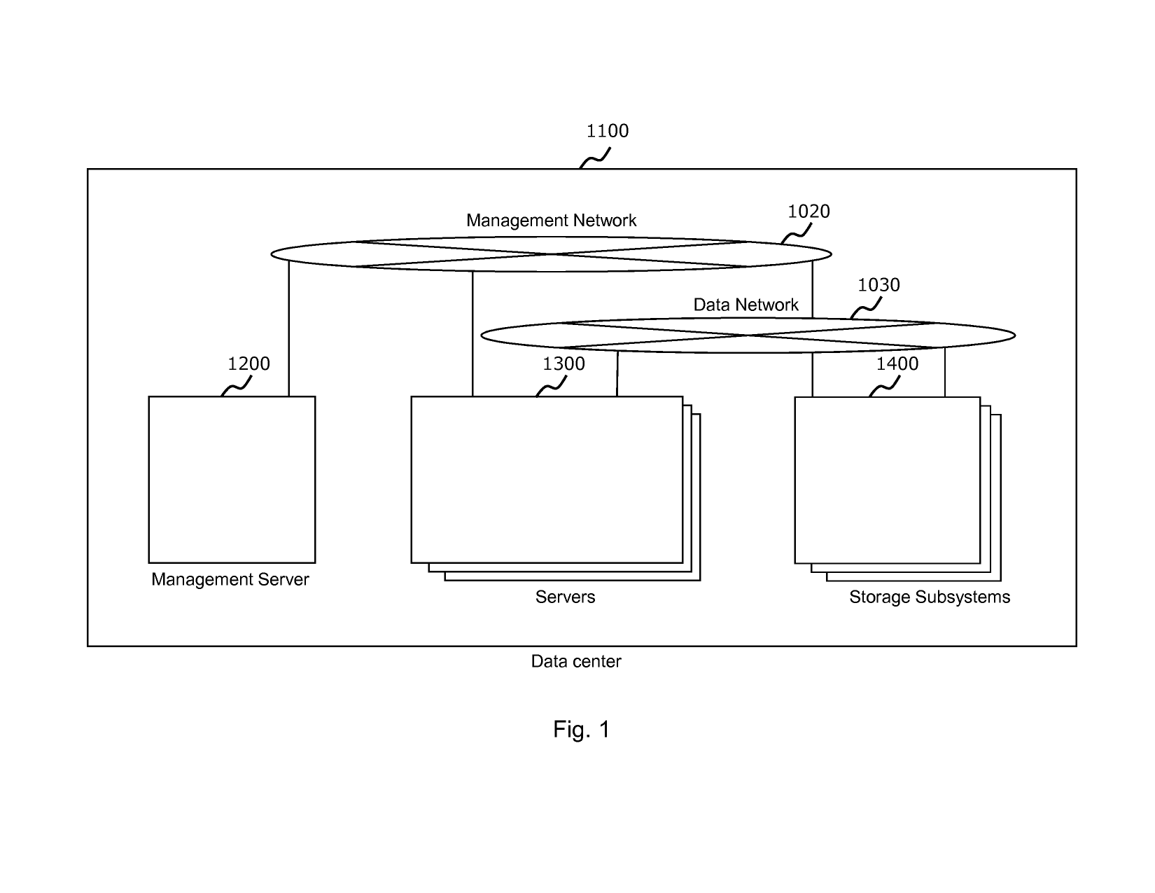

FIG. 1 illustrates a system configuration in accordance with the first exemplary embodiment. In an exemplary system configuration, data center 1100 utilizes servers 1300, storage subsystems 1400 and a management server 1200. The servers 1300 and storage subsystems 1400 are interconnected via data network 1030. The data network 1030 is a Storage Area Network (SAN) in the first exemplary embodiment. However, other types of networks may be substituted therefor by those skilled in the art.

The servers 1300, the storage subsystems 1400 and the management server 1200 are connected via a management network 1020. The management network 1020 may be an Ethernet Local Area Network (LAN). However, other types of networks may also be substituted therefor by those skilled in the art. Further, the management network 1020 and data network 1030 are illustrated as separate networks in the exemplary system configuration. Alternatively, they may be integrated.

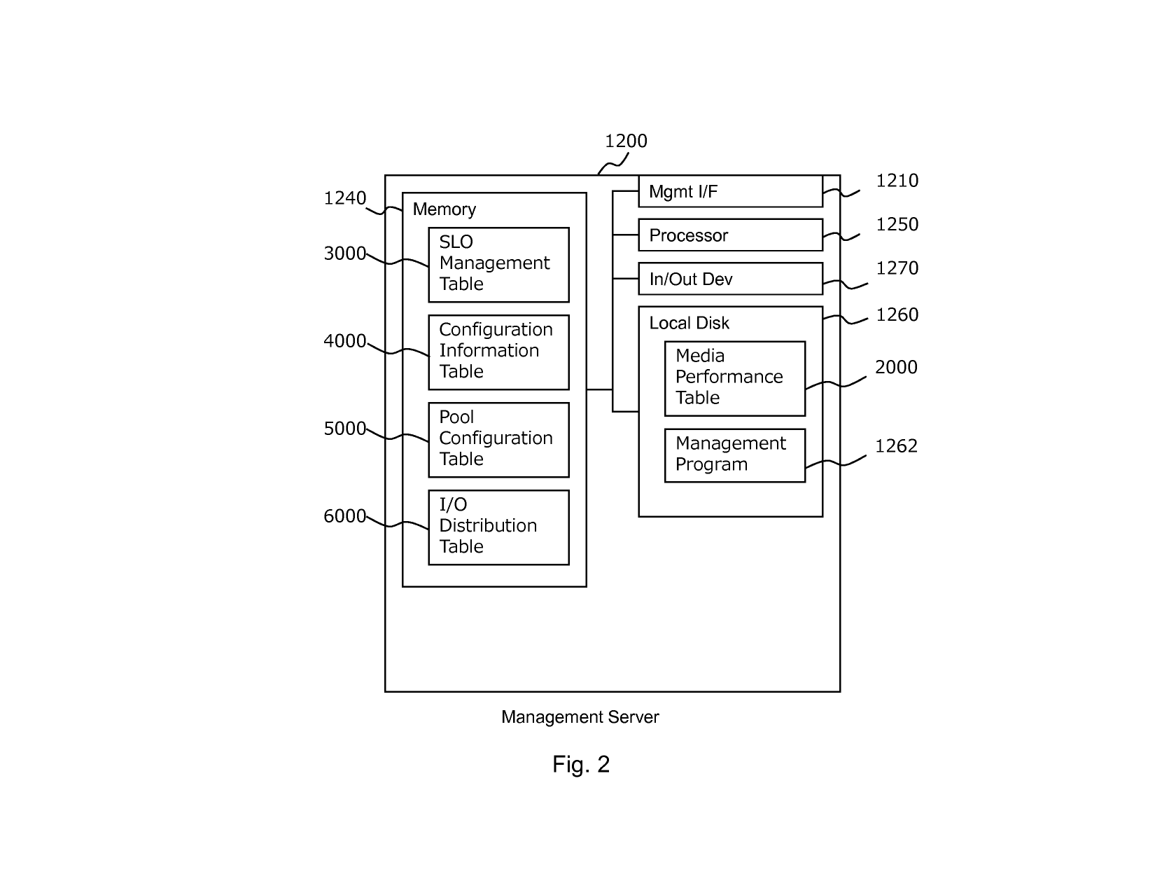

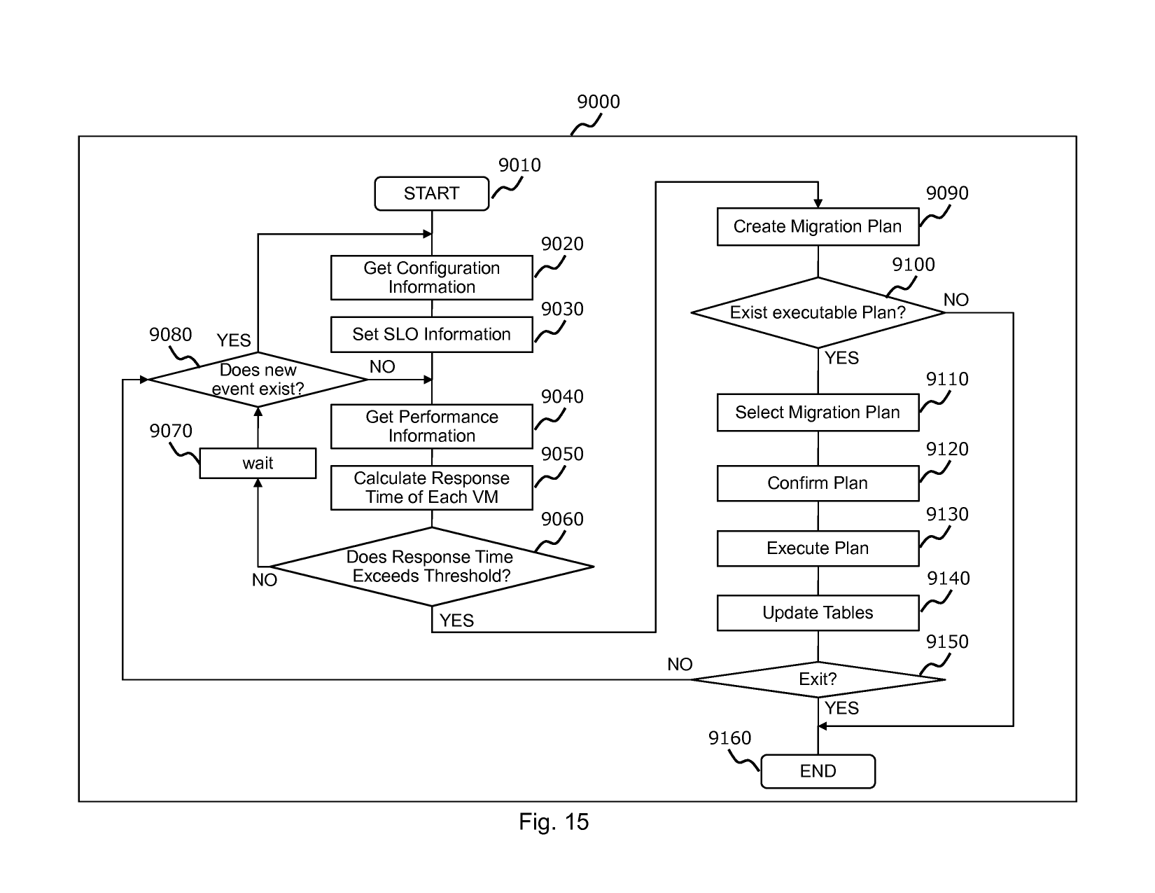

FIG. 2 illustrates a configuration of a management server 1200 of the data center 1100 in accordance with the first exemplary embodiment. The management server 1200 includes a management interface 1210, which is an interface to the management network 1020. An Input/Output (I/O) Device 1270 is a user interface such as monitor, keyboard or mouse that can be utilized to configure or interface with the management server 1200. The management server further includes a local disk 1260, which contains a media performance table 2000 and a management program 1262. The management program 1262 is loaded on a memory 1240 and executed by a processor 1250. The operations of the management program 1262 are shown in FIG. 15.

The management server 1200 utilizes a memory 1240, which contains a Service Level Objective (SLO) management table 3000, a configuration information table 4000, a pool configuration table 5000 and an I/O distribution table 6000.

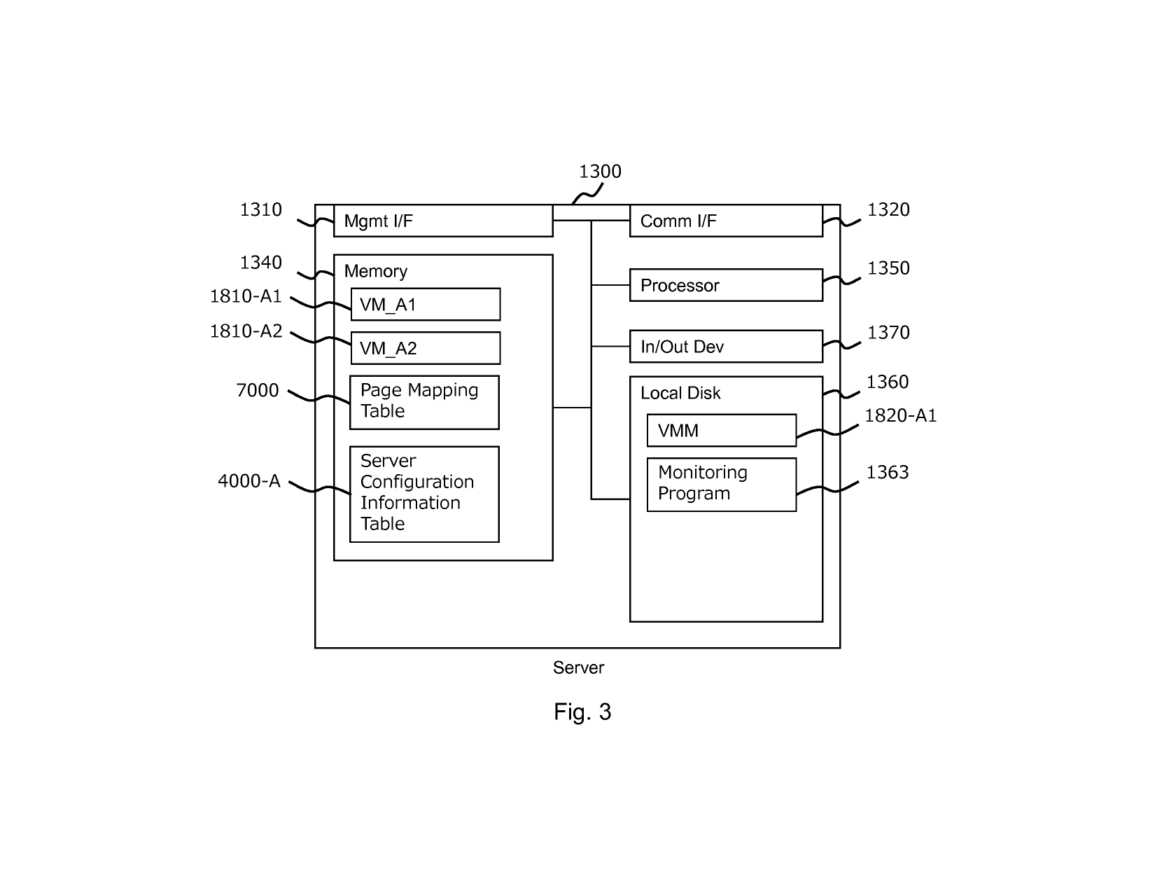

FIG. 3 illustrates a configuration of one of the servers 1300 of the data center 1100 in accordance with the first exemplary embodiment. The server 1300 utilizes a management interface 1310 as an interface to the management network 1020, and a communication interface 1320 as an interface to the data network 1030. The server 1300 utilizes a local disk 1360 which contains a Virtual Machine Manager (VMM) 1820-A1 and a monitoring program 1362. The VMM 1820-A1 is loaded to a memory 1340 and executed by a processor 1350. In an exemplary embodiment, the VMM 1820-A1 is loaded from the local disk 1360, but can also be loaded in various other ways. For example, the VMM 1820-A1 can be loaded from the storage subsystems 1400. When the VMM 1820-A1 is loaded from the storage subsystems 1400, the server 1300 does not need to utilize a local disk 1360. The operations of the monitoring program 1362 are further shown in FIG. 15.

The server 1300 utilizes a memory 1340 which contains virtual machines. In an exemplary embodiment, VM_A1 1810-A1 and VM_A2 1810-A2 are loaded from the storage subsystems 1400 and executed by a processor 1350 on VMM 1820-A1. The memory 1340 also contains a page mapping table 7000 and a server configuration information table 4000-A.

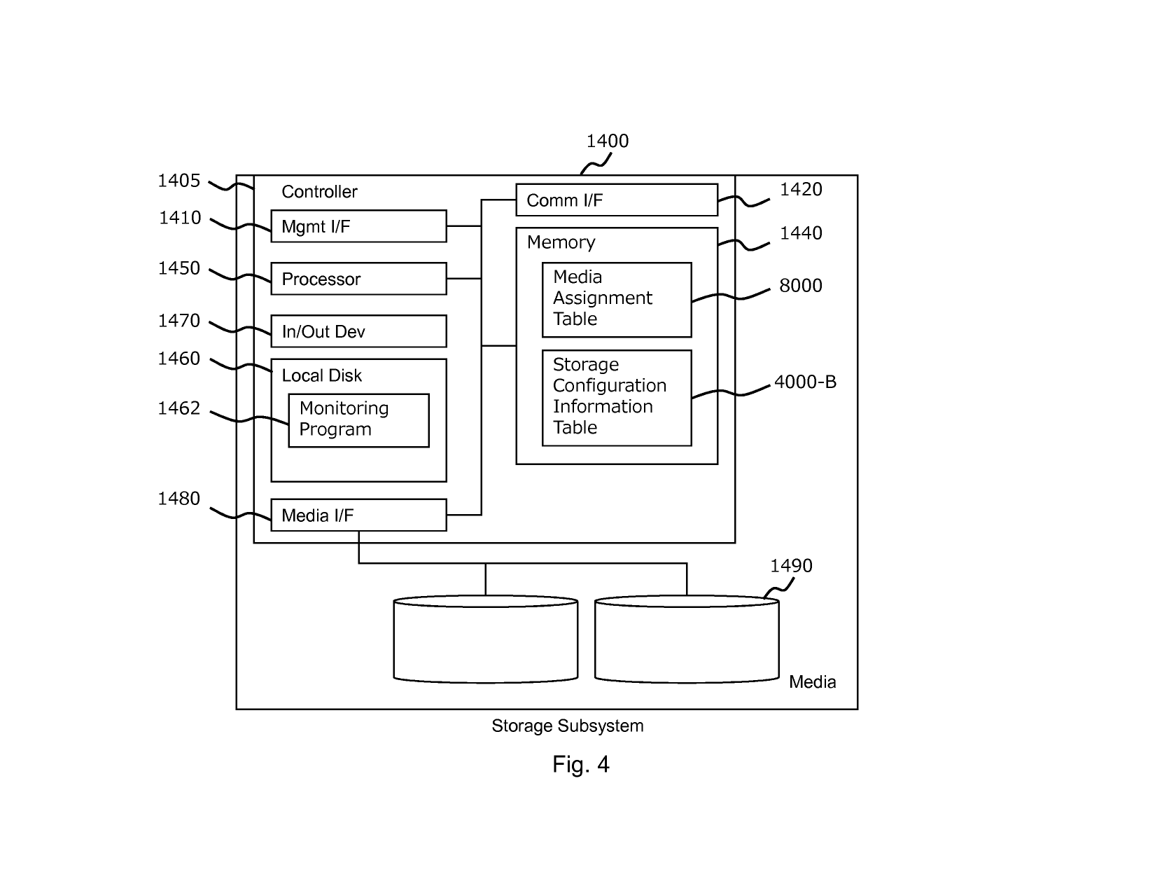

FIG. 4 illustrates an exemplary configuration of a storage subsystem 1400 of the data center 1100, in accordance with the first exemplary embodiment. The storage subsystem 1400 utilizes a controller 1405 and media 1490. The controller 1405 contains a management interface 1410, a communication interface 1420, a memory 1440, a processor 1450, a local disk 1460, an I/O device 1470 and a media interface 1480. The management interface 1410 is an interface to the management network 1020. The communication interface 1420 is an interface to the data network 1030. The media interface 1480 is an interface to the storage media 1490.

The storage subsystem 1400 also utilizes a monitoring program 1462, which is loaded to memory 1440 and executed by processor 1450. This program monitors the configuration and the performance of the storage subsystem 1400 and creates a media assignment table 8000 and a storage configuration information table 4000-B.

The storage media 1490 may include more than one storage media. In the example illustrated in FIG. 4, two Hard Disk Drives (HDDs) are depicted, however, any number of media in combination with any type of media may be substituted therefor. For example, other media such as Solid State Disks (SSDs) can be utilized. Additionally, various HDDs such as Serial Attached Small computer system interface drives (SAS), Serial Advanced Technology Attachment drives (SATA) and SSDs can be mixed.

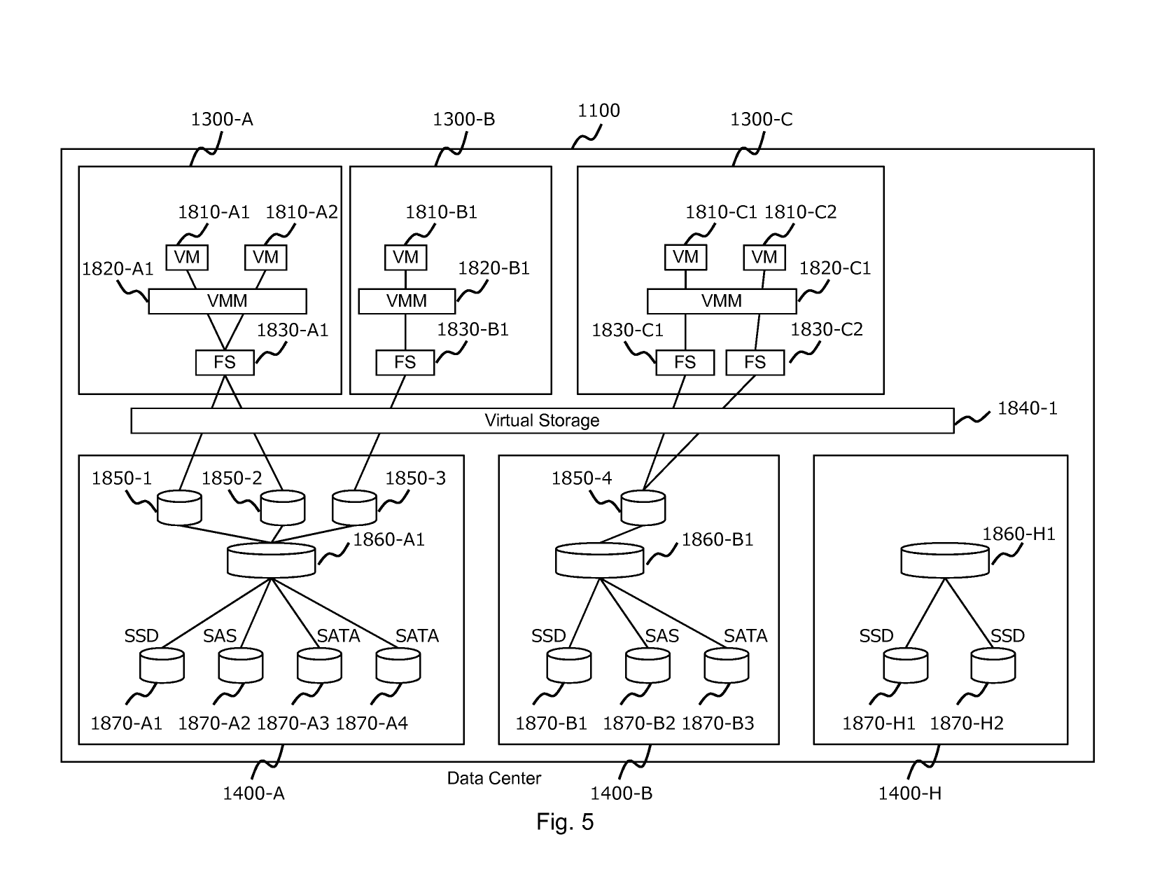

FIG. 5 illustrates a logical configuration of the system from the virtual machine to the physical volumes in accordance with the first exemplary embodiment.

Each Virtual Machine (VM) 1810-A1, 1810-A2, 1810-B1, 1810-C1, 1810-C2 is executed on its corresponding Virtual Machine Manager (VMM) 1820-A1, 1820-B1, 1820-C1. Each VM is associated with a corresponding File System (FS) 1830-A1, 1830-B1, 1830-C1, 1830-C2. The image of the virtual machine is stored in the storage subsystem 1400 and loaded into the server 1300. Multiple VMs can be deployed on one VMM. Multiple VMs can also share a common FS. In the example illustrated in FIG. 5, five VMs are deployed in one data center. However, other configurations are also possible, as would be understood by one skilled in the art.

The FS is associated with one or more corresponding virtual volumes 1850-1, 1850-2, 1850-3, 1850-4. In this example, four virtual volumes are created in one data center, however, other configurations are possible depending on the requirements of the data center.

The virtual storage subsystem 1840-1 virtualizes the multiple storage subsystems into a single virtualized storage subsystem.

The virtual volume is created from the storage pool 1860. The virtual volume can have a thin provisioning function or a dynamic storage tiering function. In the example depicted in FIG. 5, the virtual volumes have dynamic storage tiering functionality, however, other functions are possible depending on the data center requirements.

The physical volume 1870 contains physical media such as Hard Disk Drives (HDDs) or Solid State Drives (SSDs). The physical volume 1870 can also be a Redundant Array of Inexpensive Disks (RAID) group containing multiple media.

In the first exemplary embodiment, the storage subsystem 1400-H has a storage pool 1860-H1. This storage pool is reserved for emergency situations. In the first exemplary embodiment, this storage pool is not used outside of emergencies. However, this storage pool 1860-H1 could be used in non-emergency situations without modification.

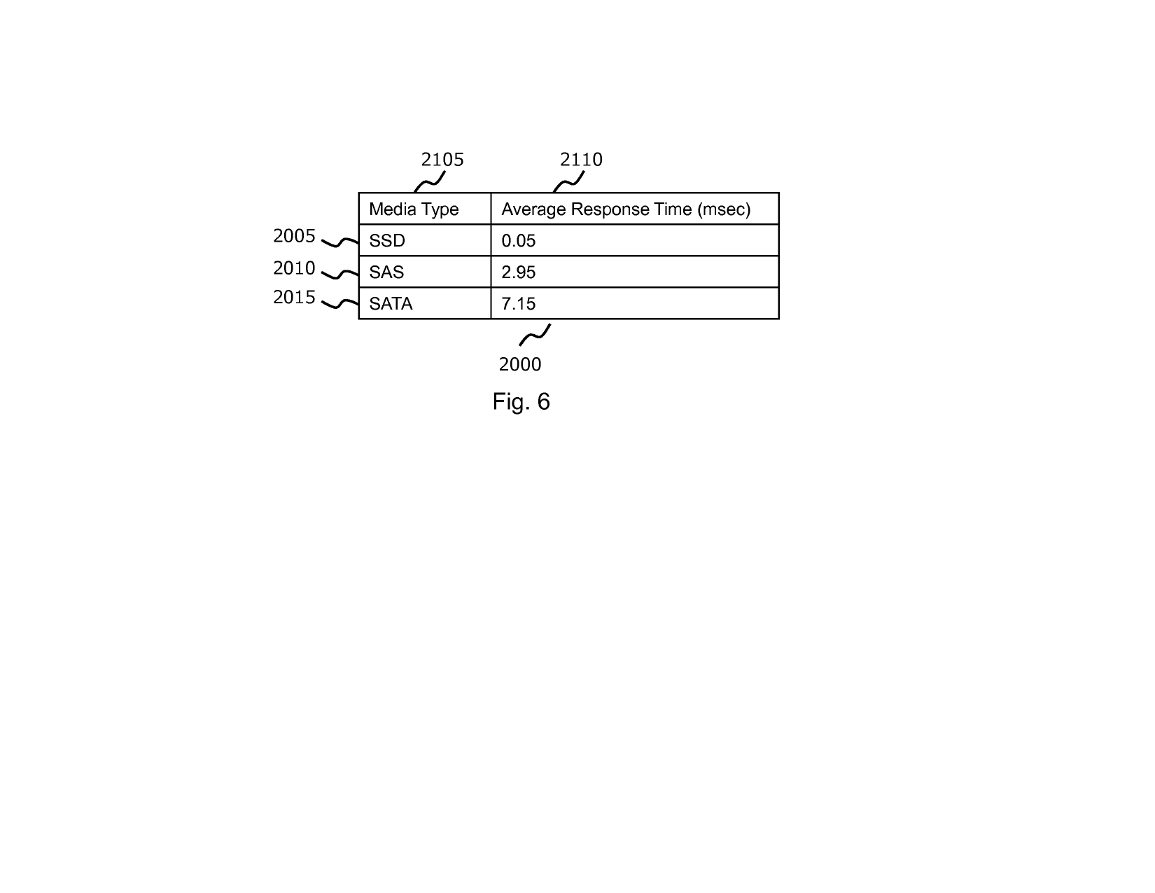

FIG. 6 illustrates a configuration of the media performance table 2000 of the management server in accordance with the first exemplary embodiment.

In the media performance table 2000, an average response time 2110, represented in milliseconds, is stored for each of the media type 2105 (e.g. SSD 2005, SAS 2010, SATA 2015). For example, SSD 2005 has an average response time of 0.05 msec.

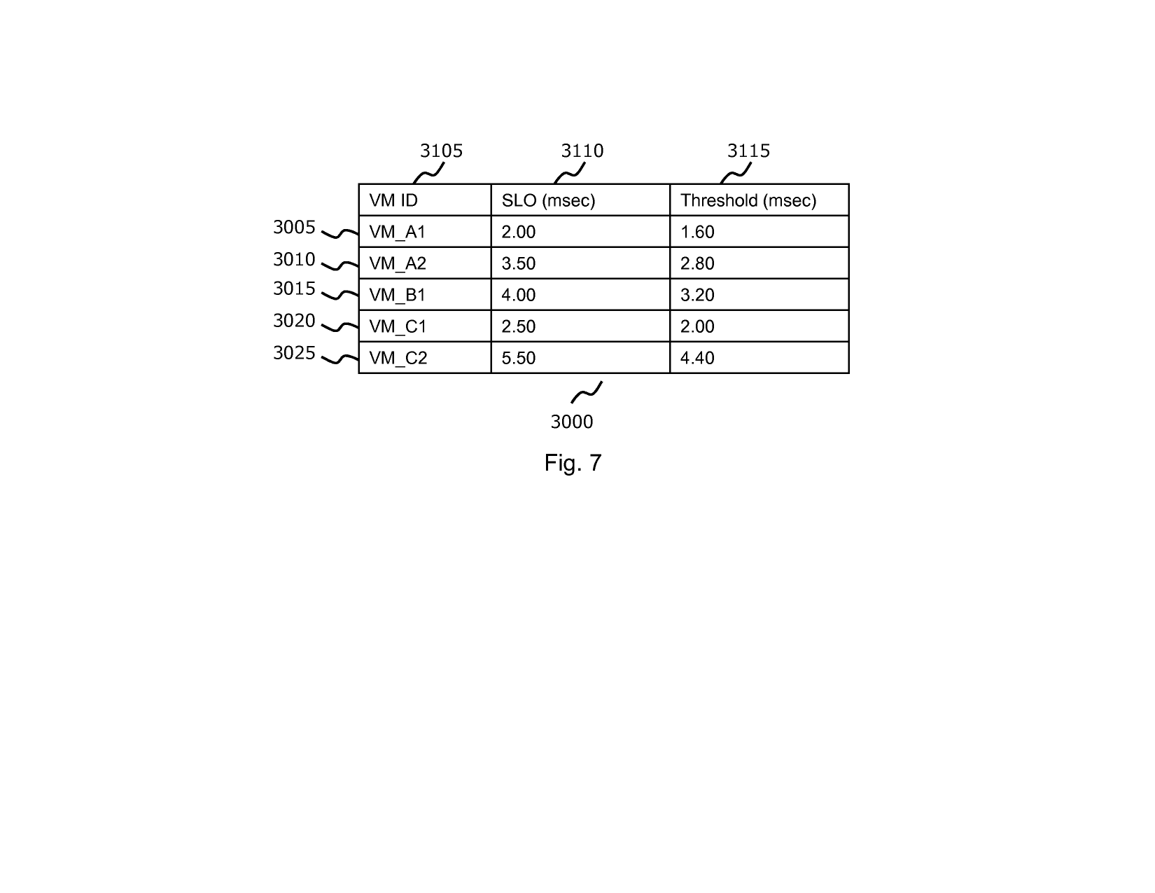

FIG. 7 illustrates a configuration of the SLO management table of the management server in accordance with the first exemplary embodiment. The SLO management table 3000 is created in the memory 1240 of the management server via the management program 1262.

The columns of the table are directed to the virtual machine identifier 3105, the SLO 3110 and the threshold 3115. The threshold represents the minimum response time allowed for a virtual machine. The rows 3005, 3010, 3015, 3020, 3025 illustrate entries for the virtual machines. For example, row 3005 defines SLO of virtual machine VM_A1 as being 2.00 msec with a threshold of 1.60 msec.

The SLO and the threshold are defined by the user. However, other methods of definition may be substituted therefor. For example, the threshold can be calculated from the SLO.

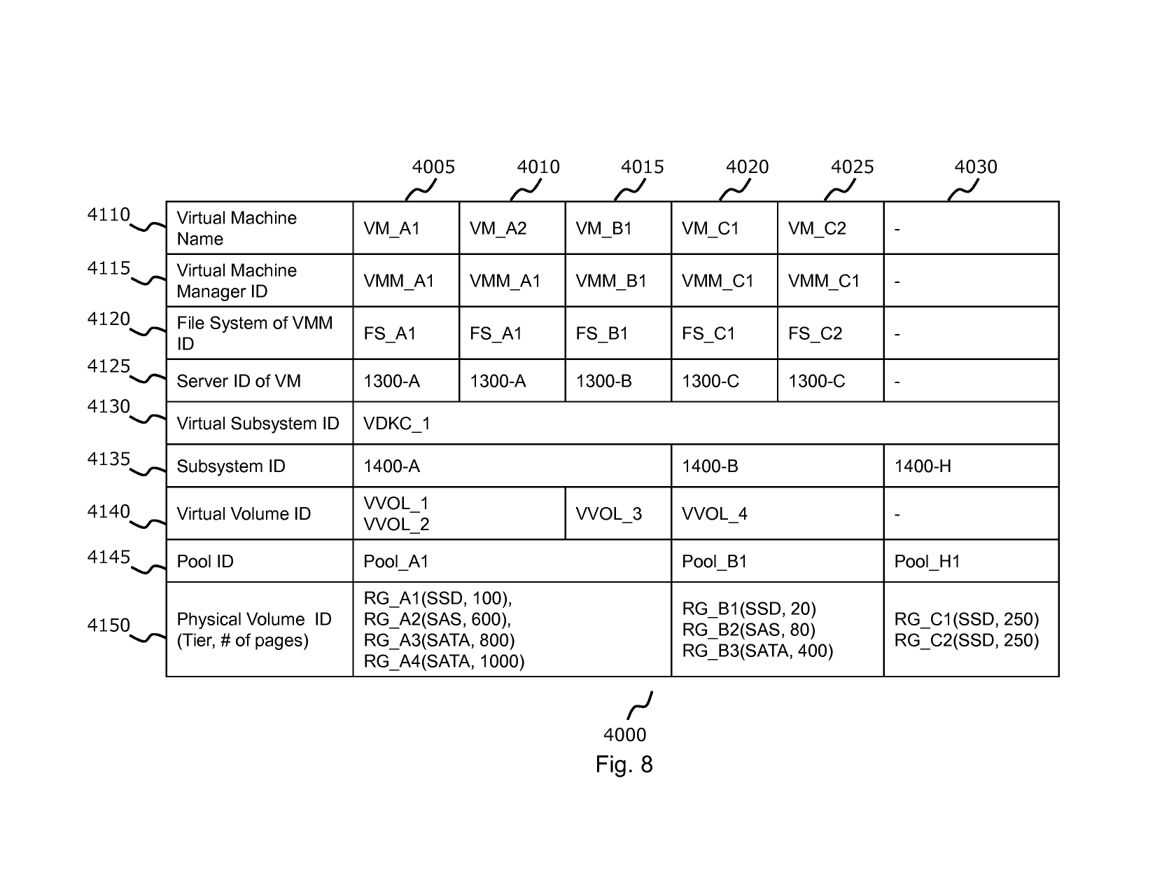

FIG. 8 illustrates a configuration of the configuration information table 4000 of the management server in accordance with the first exemplary embodiment.

The management program 1262 collects the server configuration information table 4000-A from each server as shown in FIG. 3, and the storage configuration information table 4000-B from each storage subsystem as shown in FIG. 4, to create the configuration information table 4000.

The configuration information table 4000 illustrates the logical mapping relationship between the virtual machine and the physical volume. Columns 4005, 4010, 4015, 4020, 4025 and 4030 are fields provided for the entries of each row.

The ‘Virtual Machine Name’ row 4110 shows the identification of each virtual machine 1810 in the data center 1100.

The ‘Virtual Machine Manager ID’ row 4115 shows the identification of each Virtual Machine Manager (VMM) 1820 in the data center 1100.

The ‘File System of VMM ID’ row 4120 shows the identification of each file system of the VMM 1830 in the data center 1100.

The ‘Server ID of VM’ row 4125 shows the identification of each server 1300 in the data center 1100.

The ‘Virtual Subsystem ID’ row 4130 shows the identification of each virtual storage subsystem in the data center 1100. This identification can be a serial number of the virtual storage subsystem.

The ‘Subsystem ID’ row 4135 shows the identification of each subsystem 1400 in the data center 1100.

The ‘Virtual Volume ID’ row 4140 shows the identification of each virtual volume 1850 in the data center 1100. This identification can be a logical unit number of the volume.

The ‘Pool ID’ row 4145 shows the identification of each storage pool 1860 in the data center 1100.

The ‘Physical Volume ID’ row 4150 shows the identification of each physical volume 1870 in the data center 1100. This identification can be a RAID group number of the physical volumes or logical unit number of the volumes. Additionally, this field has a media type and a number of pages of each physical volume. The media type and the page number are derived from each storage subsystem 1400.

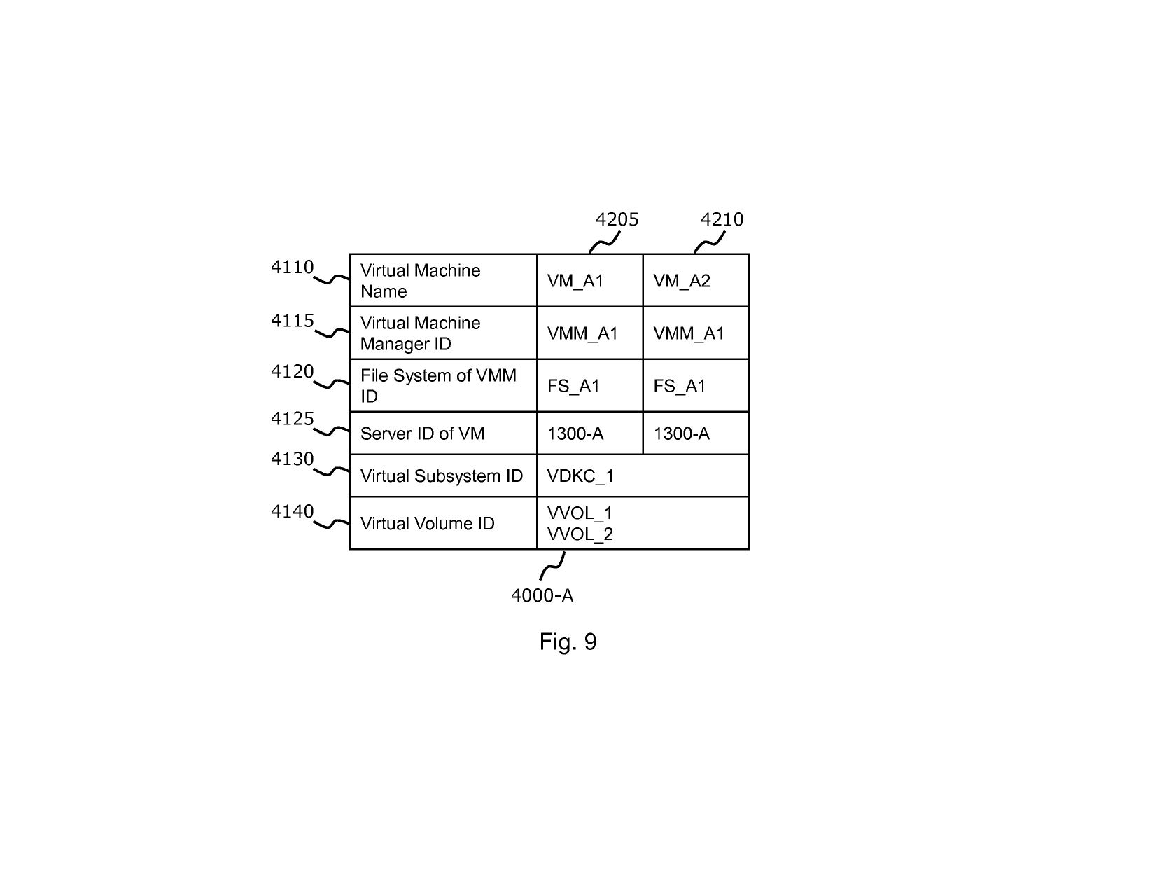

FIG. 9 illustrates a configuration of the server configuration information table of the management server in accordance with the first exemplary embodiment.

The server configuration information table 4000-A is created in the memory 1340 of the server by monitoring program 1362, and shows the logical mapping relationship between virtual volumes.

The ‘Virtual Machine Name’ row 4110 shows the identification of each virtual machine 1810 in the data center 1100.

The ‘Virtual Machine Manager ID’ row 4115 shows the identification of each Virtual Machine Manager (VMM) 1820 in the data center 1100.

The ‘File System of VMM ID’ row 4120 shows the identification of each File System of the VMM 1830 in the data center 1100.

The ‘Server ID of VM’ row 4125 shows the identification of each server (e.g. 1300-A) in the data center 1100.

The ‘Virtual Subsystem ID’ row 4130 shows the identification of each virtual storage subsystem 1840 in the data center 1100. This identification can be a serial number of the virtual subsystem.

The ‘Virtual Volume ID’ row 4140 shows the identification of each virtual volume 1850 in the data center 1100. This identification can be a logical unit number of the volume.

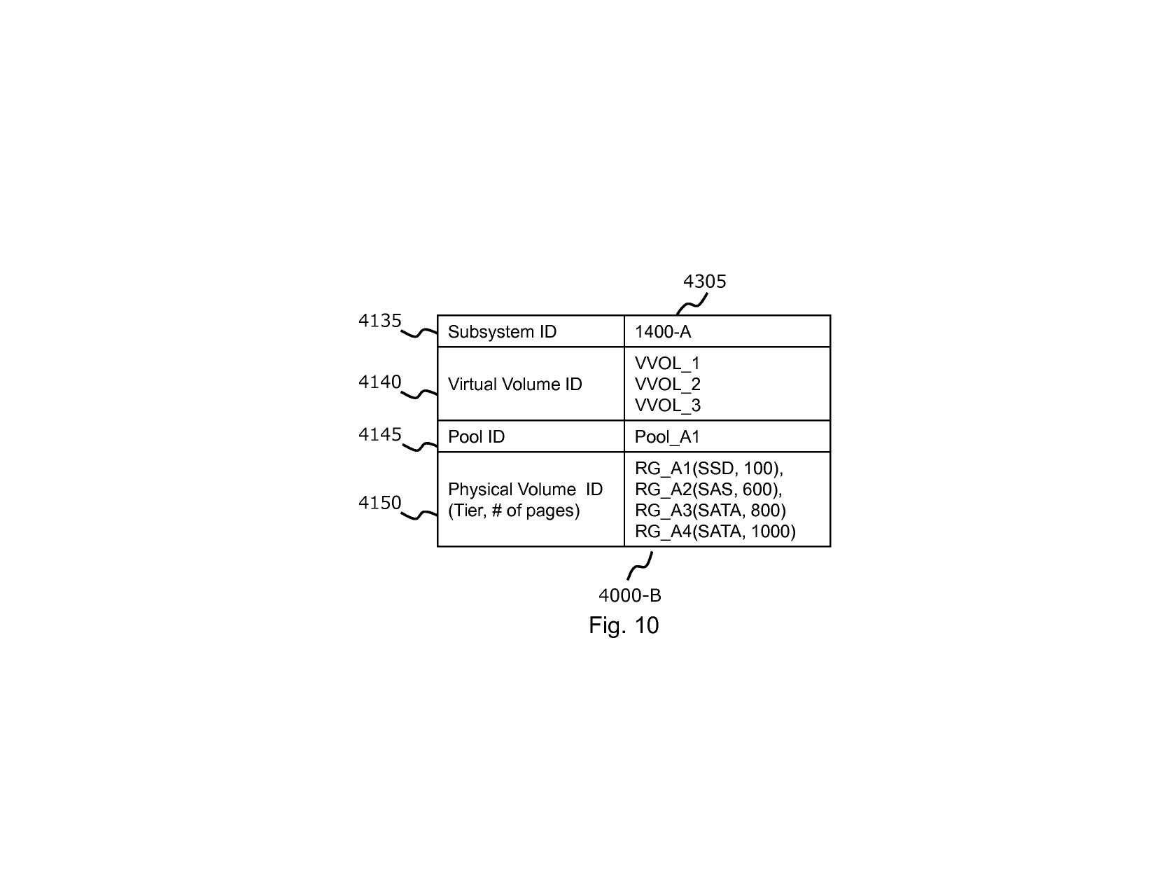

FIG. 10 illustrates a configuration of the storage configuration information table of the management server in accordance with the first exemplary embodiment.

FIG. 10 illustrates the server configuration information table 4000-B which is created in a storage memory 1440 by a monitoring program 1462. This table shows the logical mapping relationship from the subsystem to the physical volume. Column 4305 provides entries for each of the rows.

The ‘Subsystem ID’ row 4135 shows the identification of each subsystem 1400 in the data center 1100.

The ‘Virtual Volume ID’ row 4140 shows the identification of each virtual volume 1850 in the data center 1100. This identification can be a logical unit number of the volume.

The ‘Pool ID’ row 4145 shows the identification of each storage pool 1860 in the data center 1100.

The ‘Physical Volume ID’ row 4150 shows the identification of each physical volume 1870 in the data center 1100. This identification can be a RAID group number of the physical volumes or logical unit number of the volumes. Additionally, this field indicates the media type and the number of pages of each Physical Volume. The media type and the page number are derived from each storage subsystem 1400.

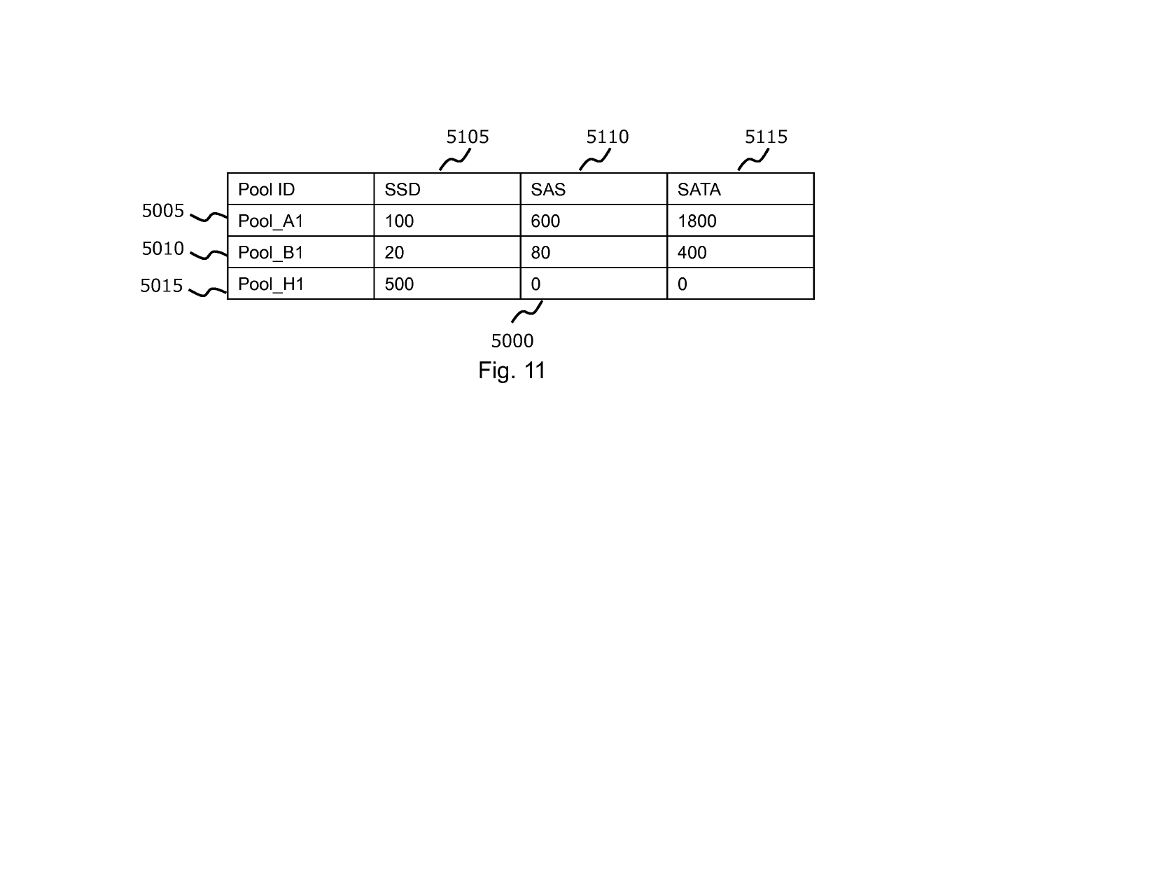

FIG. 11 illustrates a configuration of the pool configuration table of the storage subsystem in accordance with the first exemplary embodiment.

In the pool configuration table 5000, each row 5005, 5010, 5015 is a configuration of the storage pool, with each column 5105, 5110, 5115, indicating each type of storage media of the storage pool. For example, row 5005 shows that Pool_A1 has 100 pages of SSD media, 600 pages of SAS media and 1800 pages of SATA media. This table 5000 is created by the management program 1262 by using configuration information table 4000.

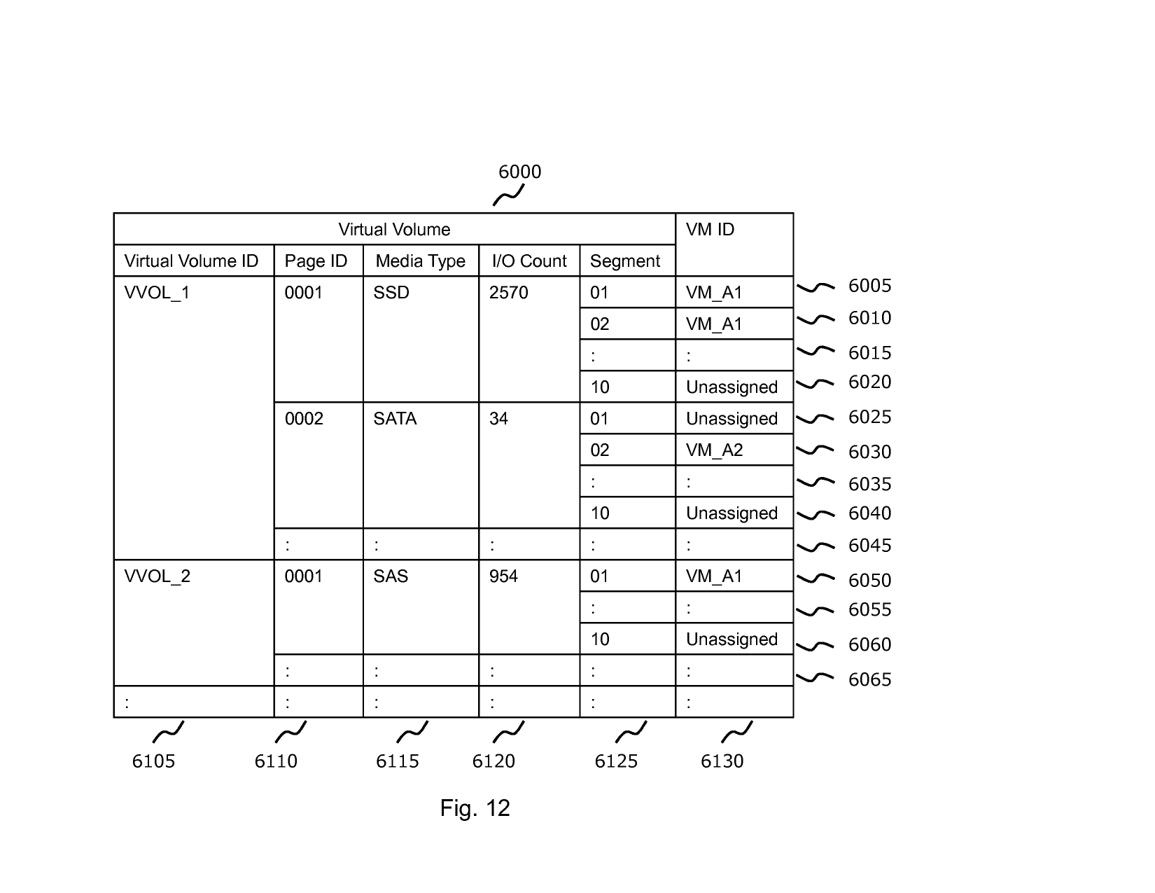

FIG. 12 illustrates a configuration of the I/O distribution table of the management server, in accordance with the first exemplary embodiment.

The I/O distribution table 6000 shows the I/O distribution and usage of each page of each virtual volume.

The management program 1262 collects the page mapping table 7000 from each server and the media assignment table 8000 from each storage subsystem. The management program 1262 creates the I/O Distribution Table 6000 from the page mapping table 7000 and the media assignment table 8000.

The page size of each virtual volume and the chunk size of each VM may be different. In the example of FIG. 12, the page size is 10 MB and the chunk size is 1 MB, however, other configurations are also possible.

The ‘Virtual Volume ID’ column 6105 shows the identification of each virtual volume 1850 in the data center 1100. This identification can be a logical unit number of the volume.

The ‘Page ID’ column 6110 shows the identification of each page of the virtual volume 1850 in the data center 1100.

The ‘Media Type’ column 6115 shows the media type of the specified page. For example, as depicted in FIG. 12, Page 0001 of the VVOL_1 is assigned to SSD media.

The ‘I/O Count’ column 6120 shows the I/O count of the specified page. For example, as depicted in FIG. 12, the number of I/Os of page 0001 of the VVOL_1 is 2570.

The ‘Segment’ column 6125 shows the identification of each segment of the each virtual volume. In the example of FIG. 12, the page size is 10 MB and the chunk size is 1 MB. Therefore 1 page is divided by 10 segments and each segment is assigned based on each chunk.

The ‘VM ID’ column 6130 shows the identification of each VM ID that the specified segment is assigned. For example, VM_01 is assigned to the segment 01 of the page 0001 of the virtual volume VVOL_1. Entries 6005, 6010, 6015, 6020, 6025, 6030, 6035, 6040, 6045, 6050, 6055, 6060 and 6065 illustrate various virtual machines grouped according to their respective virtual volume.

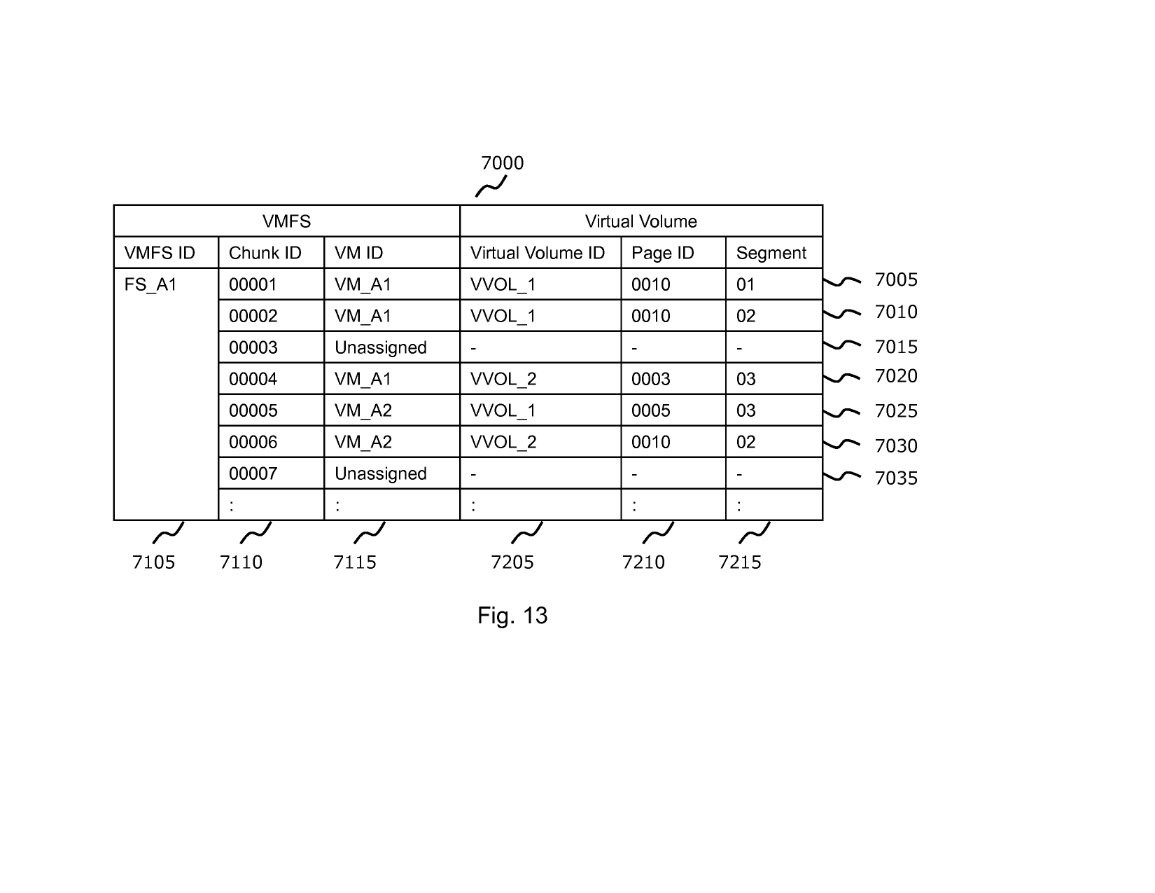

FIG. 13 illustrates a configuration of the page mapping table of the server in accordance with the first exemplary embodiment.

The page mapping table 7000 is created in server memory 1340 by monitoring program 1362. This table 7000 shows the mapping relationship from the chunk of the VMFS to the page of the virtual volume.

The ‘VMFS ID’ column 7105 shows the identification of each VMFS 1830.

The ‘Chunk ID’ column 7110 shows the identification of each chunk of each VMFS 1830. Each chunk is managed by VMFS and assigned to each VM.

The ‘VM ID’ column 7115 shows the identification of each VM.

Each chunk is assigned to each segment of the each page of the virtual volume. The ‘Virtual Volume ID’ row 7205 shows the identification of each virtual volume. The ‘Page ID’ column 7210 shows the identification of each page. The ‘Segment’ column 7215 shows the identification of each segment. Rows 7005, 7010, 7015, 7020, 7025, 7030, and 7035 illustrate an association of each chunk to each virtual volume.

For example, row 7005 indicates that chunk 00001 of the FS_A1 is assigned to VM_A1, and this chunk is assigned to the segment 01 of the Page 0010 of the virtual volume VVOL_1.

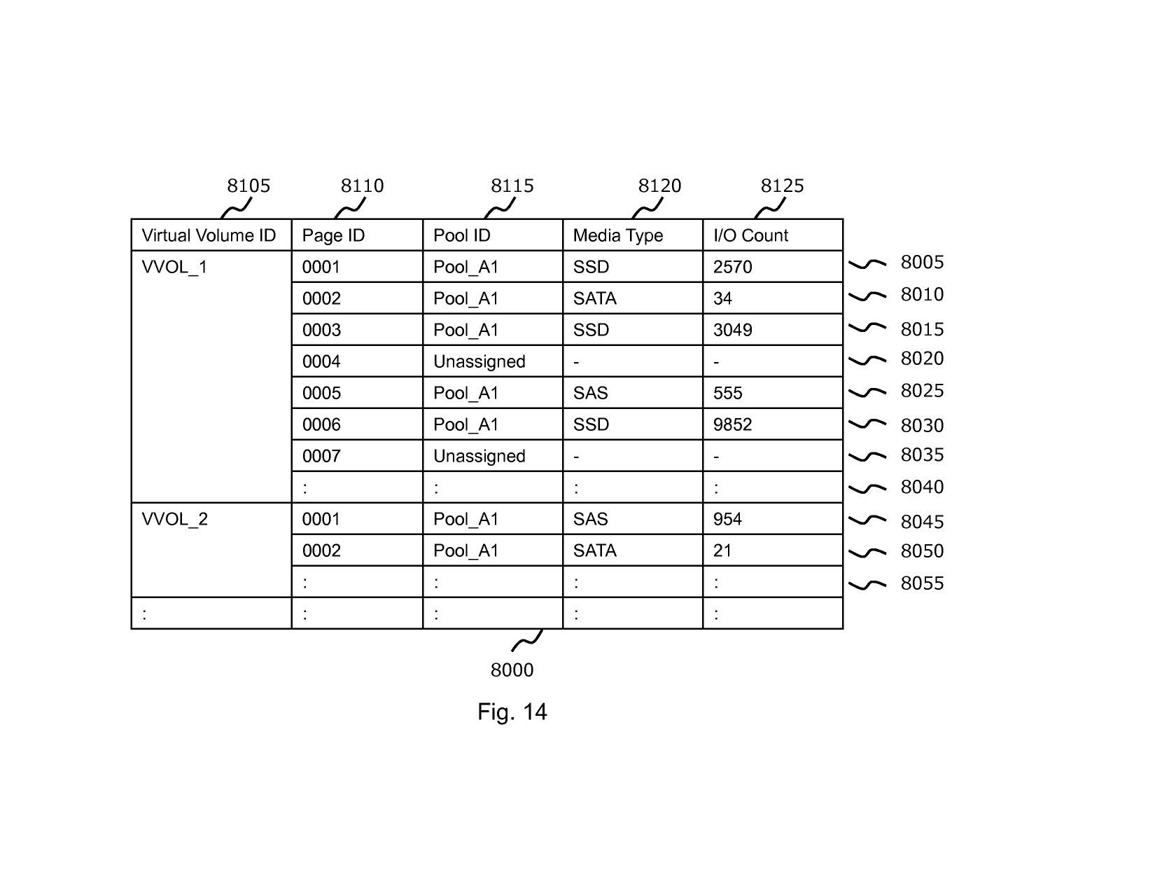

FIG. 14 illustrates a configuration of the media assignment table of the storage subsystem in accordance with the first exemplary embodiment.

The media assignment table 8000 is created in the storage subsystem memory 1440 by the monitoring program 1462. This table shows information regarding each page.

The ‘Virtual Volume ID’ column 8105 shows the identification of each virtual volume 1850.

The ‘Page ID’ column 8110 shows the identification of each page of each virtual volume 1850.

The ‘Pool ID’ column 8115 shows the identification of each storage pool from which each virtual volume 1850 is provisioned.

The ‘Media Type’ column 8120 shows the media type of each page.

The ‘I/O Count’ column 8125 shows the I/O count of each page.

Rows 8005, 8010, 8015, 8020, 8025, 8030, 8035, 8040, 8045, 8050, and 8055 illustrate exemplary entries of the table. For example, row 8005 illustrates that virtual volume VVOL_1 is provisioned from Pool_A1. The media type of the page 0001 of the virtual volume VVOL_1 is SSD and I/O count of the page 0001 of the virtual volume VVOL_1 is 2570.

FIG. 15 illustrates a flowchart of the management program 1262 of the management server in accordance with the first exemplary embodiment.

The procedure begins at Step 9010. At Step 9020, configuration information is obtained and various tables are generated. The server configuration information table 4000-A is obtained from the monitoring program 1362 from each server 1300. The storage configuration information table 4000-B is obtained from the monitoring program 1462 from each storage subsystem 1400. From these tables 4000-A and 4000-B, the configuration information table 4000 is created. The pool configuration table 5000 is also created based on the configuration information table 4000.

At Step 9030 the SLO management table 3000 is created. Virtual machine information is derived from the configuration information table 4000, and the SLO and the threshold are defined by the user. However, the threshold can also be defined by a rule or policy instead. For example, the threshold can be set to 80% of the SLO.

At Step 9040, the performance information is obtained and the response time is calculated for each virtual machine. The page mapping table 7000 is obtained from the monitoring program 1362 from each server 1300. The media assignment table 8000 is obtained from the monitoring program 1462 from each storage subsystem 1400. From these tables, the I/O distribution table 6000 is created.

At Step 9050, the response time of each virtual machine is estimated. The media type and I/O count of each page may be acquired from the page monitoring table 7000. The performance of each media may be acquired from the media performance table 2000. From the above information, the response time of each VM is thereby estimated. Although the VM is managed by chunk, the I/O count is managed by page. In the example shown in FIG. 15, one page is made up of 10 chunks. The estimation of the I/O count is calculated based on the chunks and pages. For example, suppose that VM_A1 uses two chunks at some page, the I/O count of the page is 350 and seven chunks are assigned to some VMs, thereby leaving three chunks are unassigned. In the above example, the I/O count of VM_A1 in the page is estimated by following equation:

(I/O count of the page)*(unassigned chunks)/(assigned chunks)=350*2/7=100.

Therefore, the estimation of the I/O count of VM_A1 in this page is 100. By using the above methodology, the management program 1262 can estimate the response time of each virtual machine.

At Step 9060, the management program checks for the virtual machines with the response times that exceed the threshold. If there is a virtual machine with a response time that exceeds the threshold, the management program proceeds to Step 9090, otherwise, the management program proceeds to Step 9070.

At Step 9070 the management program lets a predetermined period elapse and then proceeds to Step 9080 to check whether a new event exists. If a new event exists, then the management program continues to Step 9020, otherwise, the management program proceeds to Step 9040.

At Step 9090, the management program creates an executable migration plan. An ‘Executable’ plan means that the created plan satisfies the SLO. For example, suppose that VM_A1 exceeds the threshold and that VM_A1 uses Pool_A1. Pool_A1 is used by virtual volumes VVOL_1, VVOL_2 and VVOL_3. For each virtual volume, the management program thereby creates a partial migration plan to the storage pool Pool_A1 in the high-performance storage subsystem 1400-H.

The partial migration process can be conducted as follows. Hot spots of a specified virtual volume are migrated to a high-performance storage containing high-performance media such as SSD. The remaining parts of the virtual volume are not migrated. All accesses to the migrated portions of the virtual volume are directed to the high-performance storage system. However, if the target of access is the remaining parts, the access is directed to the original storage system of the virtual volume.

The virtual volumes may employ statuses to indicate the migration of the virtual volume, to provide an indication as to where the I/O requests directed to the virtual volume will be handled, and also to provide future reference as to which of the virtual volumes are partially migrated. For example, if the data center couples a first storage subsystem and a second storage subsystem together, then a first status may indicate that a plurality of I/O requests sent to the virtual volume will be executed by the respective storage system (e.g. a virtual volume in a first storage system set at a first status will have the plurality of I/O requests handled by the first storage system). Similarly, a second status may indicate that the plurality of I/O requests directed to the virtual volume is to be executed by both the first storage system and the second storage system. In this example, if the virtual volume is stored in the first storage system, the virtual volume may be partially migrated to the second storage system to have the I/O requests handled by both storage systems. The second status thereby indicates that the corresponding virtual volume is partially migrated. Other attributes resulting from the partial migration may also be associated with the statuses (e.g. redirecting some or all of the write data directed to the virtual volume to be stored in the second storage system as part of the second status, changing the status from the second status back to the first status upon conducting a turn back of the virtual volume from the second storage system, etc.).

The management program may create a migration plan for VVOL_1 as follows. First, the management program creates a plan. All of the SSD media pages of VVOL_1 are migrated to the storage pool Pool_H1 in the high-performance storage subsystem 1400-H. The remaining SAS and SATA media pages are not migrated. The management program then estimates the response time of each VM. At Pool_A1, the SSD media which are used by VVOL_1 become unused, thereby freeing the SSD media for use by other VMs. The management program estimates the response time of each VM based on the reassignment simulation. The management program then evaluates the created plan and adjusts the plan as needed. For example, if the response times of the VMs are below each threshold, the plan is adopted as the migration plan of VVOL_1. Otherwise, the plan is modified. In the high-performance storage subsystem 1400-H, the amount of SSD media to assign VVOL_1 increase and recalculate the response time of each VM based on the reassignment simulation.

If more than one of the response times of the VMs are not below the threshold, all of the data of VVOL_1 is migrated to the high-performance storage subsystem 1400-H, thereby indicating that the plan creation failed for VVOL_1. In this case, no plan is created for VVOL_1.

The management program would then repeat the same procedures for the VVOL_2 and VVOL_3 and subsequent virtual volumes.

At Step 9100, the management program checks whether an executable plan exists. If an executable plan exists, the management program proceeds to Step 9110; otherwise, the management program notifies the user with an error message and proceeds to Step 9160. In the latter case, the user may need to take some kind of action. For example, the user may need to add high-performance media to the storage pool.

At Step 9110, a migration plan is selected. The plan can be selected by the user, or by the management server. The user can select the appropriate plan, or the management server can select the plan based on a rule or policy. For example, the management server can select the virtual volume with the highest number of SSDs. Or, the management server can select the virtual volume with the largest I/O.

At Step 9120, the selected plan is provided to the user. The user can schedule the plan for immediate execution or a scheduled execution. If a scheduled execution is specified, the plan is registered to the scheduler.

At Step 9130, the created plan is executed. When the execution of the plan is completed, the configuration information is updated at Step 9140. Various tables are obtained and referenced. The server configuration information table 4000-A is obtained from the monitoring program 1362 from each server 1300. The storage configuration information table 4000-B is obtained from the monitoring program 1462 from each storage subsystem 1400. The configuration information table 4000 is thereby updated based on the aforementioned tables. The pool configuration table 5000 is also updated based on the configuration information table 4000.

At Step 9150, the management program checks for a termination indication by the user. If a termination indication exists, the management program proceeds to Step 9160, otherwise, the management program proceeds to step 9080.

At step 9160, the procedure ends.

After the completion of the partial migration, all of the I/Os of the partially migrated virtual volume are redirected to the high performance storage subsystem. Read access is handled as follows. If the target of the access is the page that is partially migrated to the high performance storage subsystem, the access is processed by the high-performance storage subsystem. Otherwise, the access is delegated to the original storage subsystem, which has a cache in the controller. If the requested data is in the cache, then the read access process may not need to be executed and the requested data may be returned from the cache instead.

For the write access, the procedures used to conduct write access may have some variations. For example, all of the write data can be stored in the SSD media in the high performance storage subsystem. Generally, write data undergoes a read access just after the write process is completed. Therefore, storing the write data onto the SSD media can render the data available for read access. The write data can also be stored in the original storage subsystem, if the write data is not referred to frequently for read access. The user can also select the location of the write if needed. Alternatively, all of the write data can be stored to the original storage subsystem, whereupon data experiencing an Input/Output per second (IOPS) below the threshold can be partially migrated as needed. After the completion of the partial migration, all of the I/Os of the partial migrated virtual volume are forwarded to the high-performance storage subsystem.

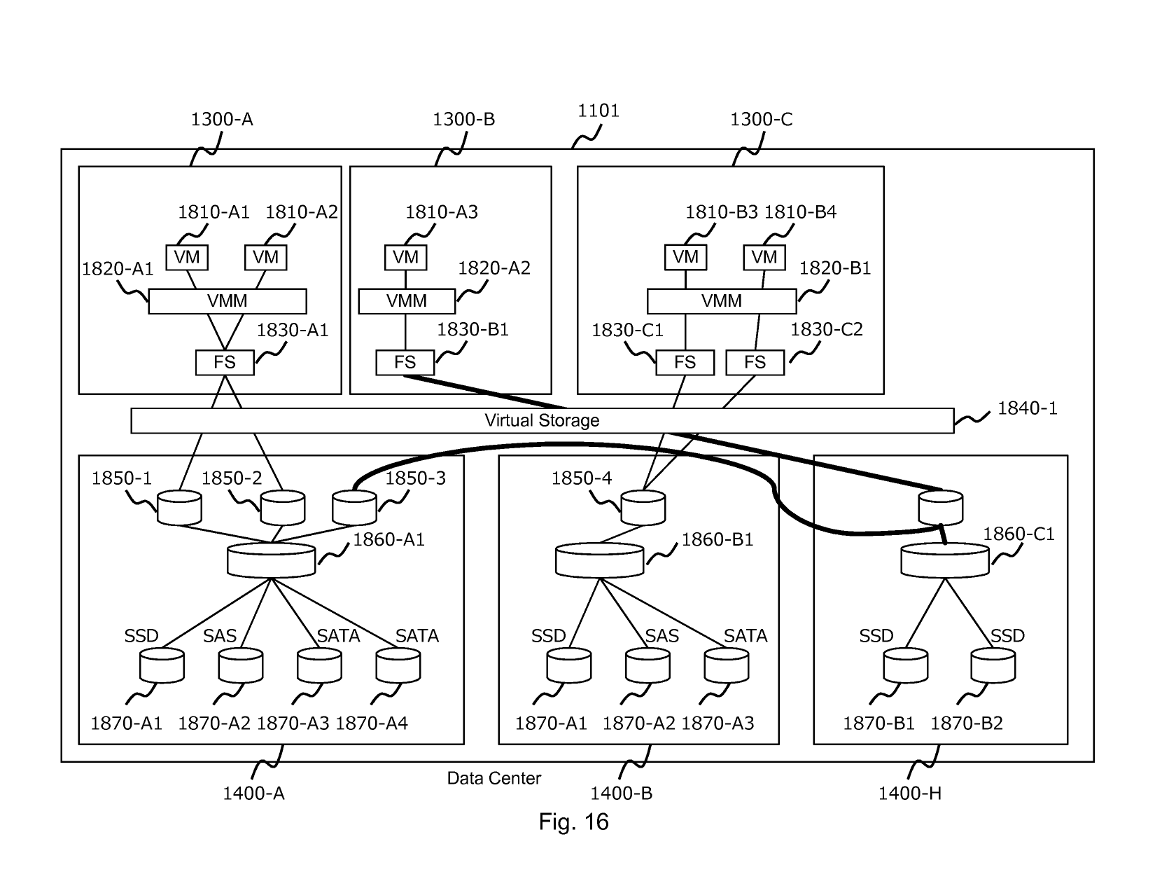

FIG. 16 illustrates a logical configuration of the system in accordance with the first exemplary embodiment. This figure illustrates the logical configuration of the system 1101 from the virtual machine to the physical volume after the migration plan is executed. In the example depicted in FIG. 16, VVOL_3 is selected as a target of migration. The high-performance media of VVOL_3 is migrated to the high-performance storage subsystem 1400-H and the remaining media stays in the original storage subsystem 1400-A. By migrating part of the virtual volume, all of the virtual volumes can satisfy the SLO.

### Second Exemplary Embodiment

The second exemplary embodiment contains a variation of Step 9110 of FIG. 15 in comparison with the first exemplary embodiment.

In the second exemplary embodiment, the management program 1262 selects a plan such that the number of I/Os between storage subsystems are reduced.

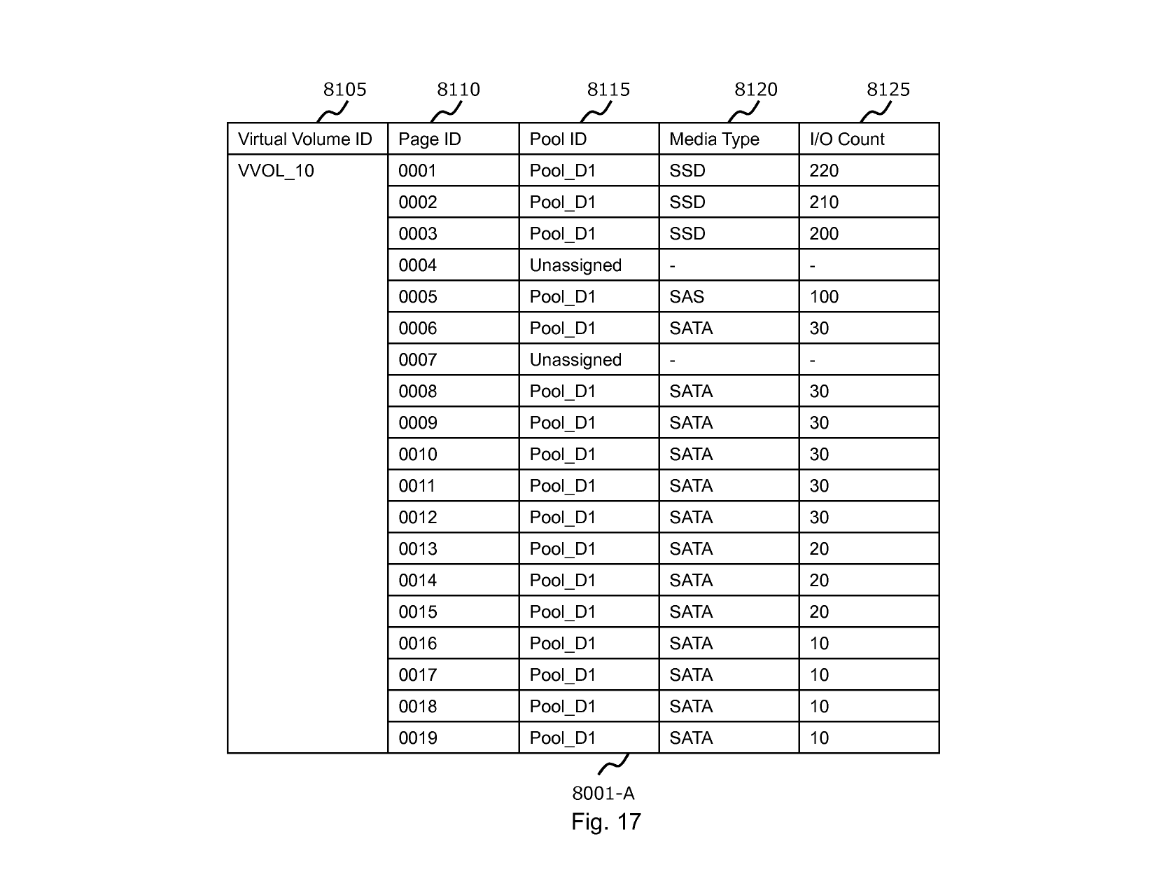

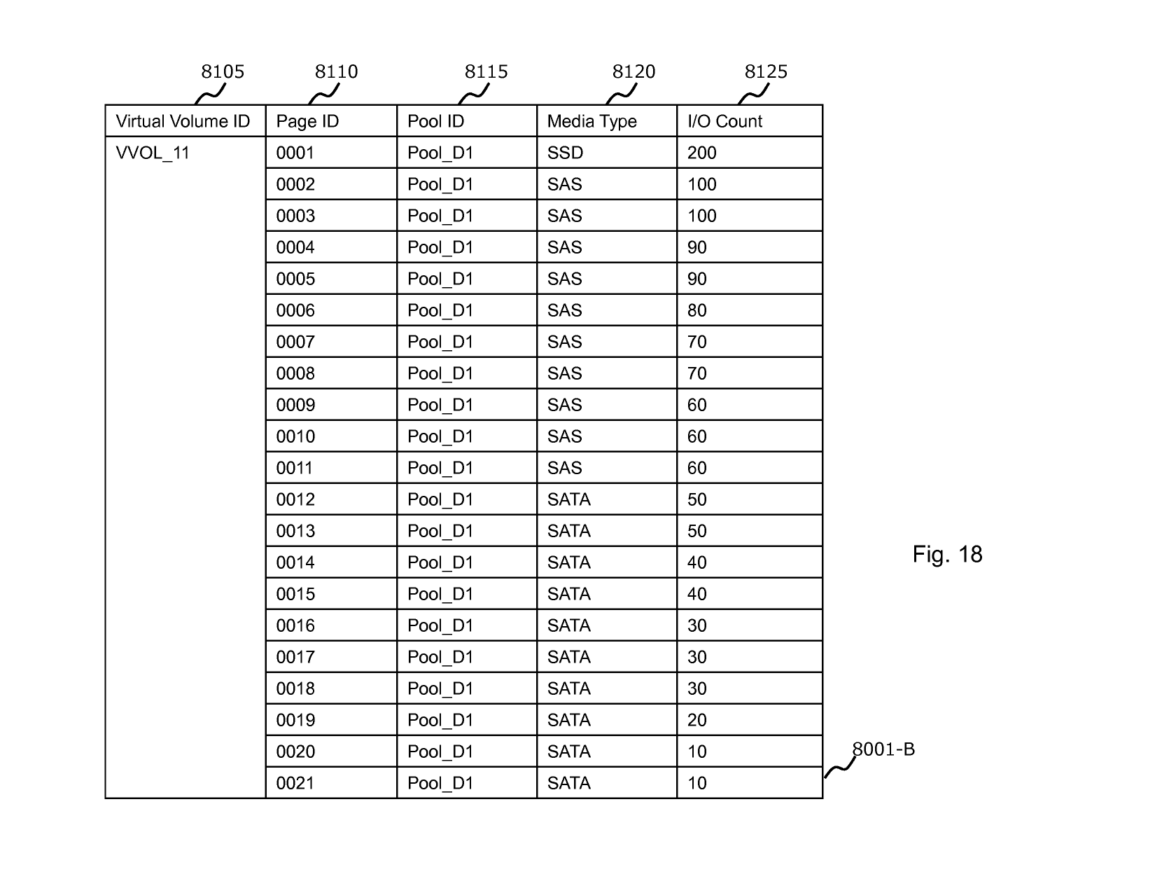

FIG. 17 and FIG. 18 illustrate media assignment tables in accordance with the second exemplary embodiment. For illustration purposes, it is presumed that Pool_D1 is used by two virtual volumes VVOL_10 and VVOL_11. FIG. 17 and FIG. 18 illustrate the media assignment tables 8001-A and 8001-B acquired from each server 1300. Here, the configuration of the media assignment table is the same as FIG. 14.

In the second exemplary embodiment the following two plans are created from step 9090 of FIG. 15: 1) 3 pages of VVOL_10 are migrated to high-performance storage, 2) 1 page of VVOL_11 is migrated to high-performance storage. The I/O count may be estimated to ensure these two plans satisfy the SLO.

The management server can select one of above plans by a variation of Step 9110 in FIG. 15. The management program can obtain the I/O distribution of each page of each virtual volume from the media assignment tables 8001-A and 8001-B. By using this I/O distribution, the management program can estimate the number of I/Os delegated from the high-performance storage subsystem to the original storage subsystems by partial migration.

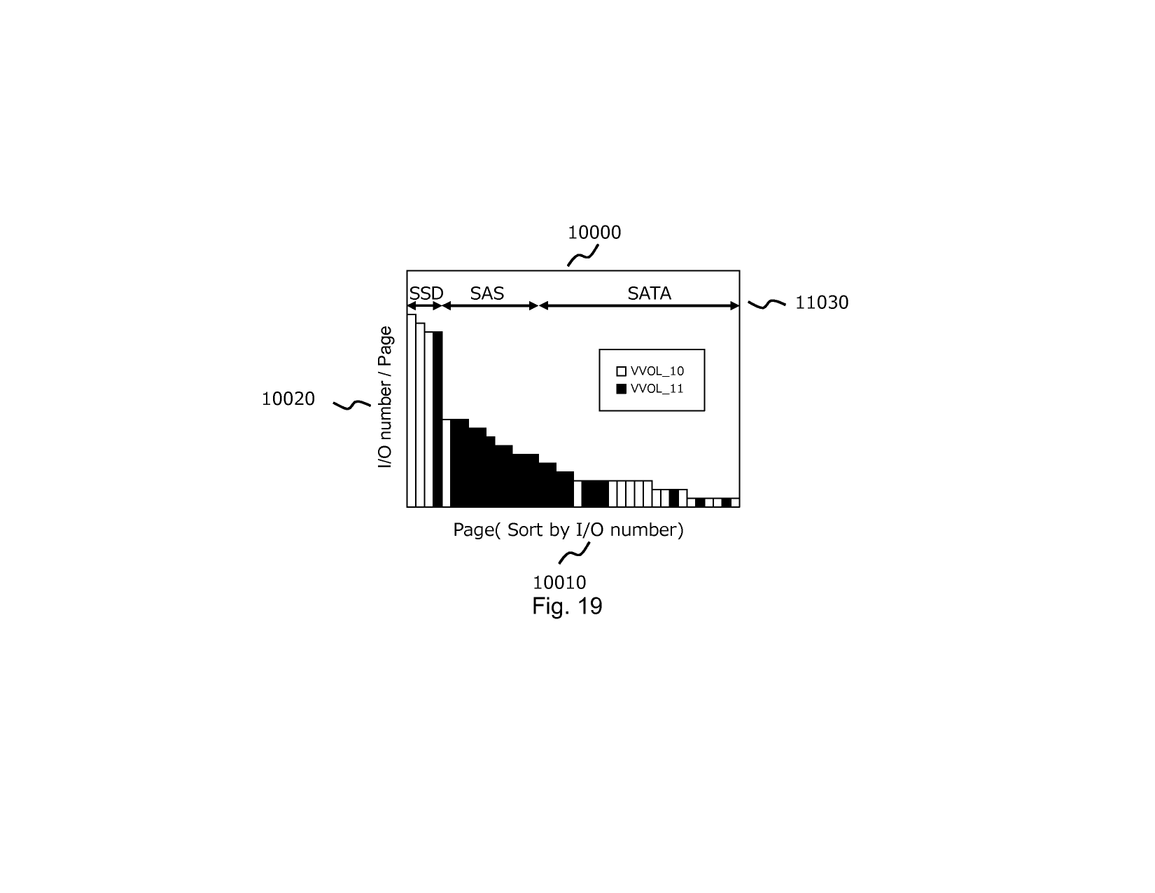

FIG. 19 illustrates a page distribution graph in accordance with the second exemplary embodiment. This figure shows the page distribution graph 10000 created from media assignment tables 8001-A and 8001-B.

The horizontal axis 10010 shows each page sorted by I/O number and also grouping of the pages by storage media 11030. The vertical axis 10020 shows the I/O number per page. White bars indicate the pages of VVOL_10 and black bars indicate the pages of VVOL_11. The page distribution graph 10000 can be created in memory 1240 of the management server 1200. Based on this graph and the created partial migration plan, the management server can estimate the number of I/Os delegated from the high-performance storage subsystem to the original storage subsystems by partial migration.

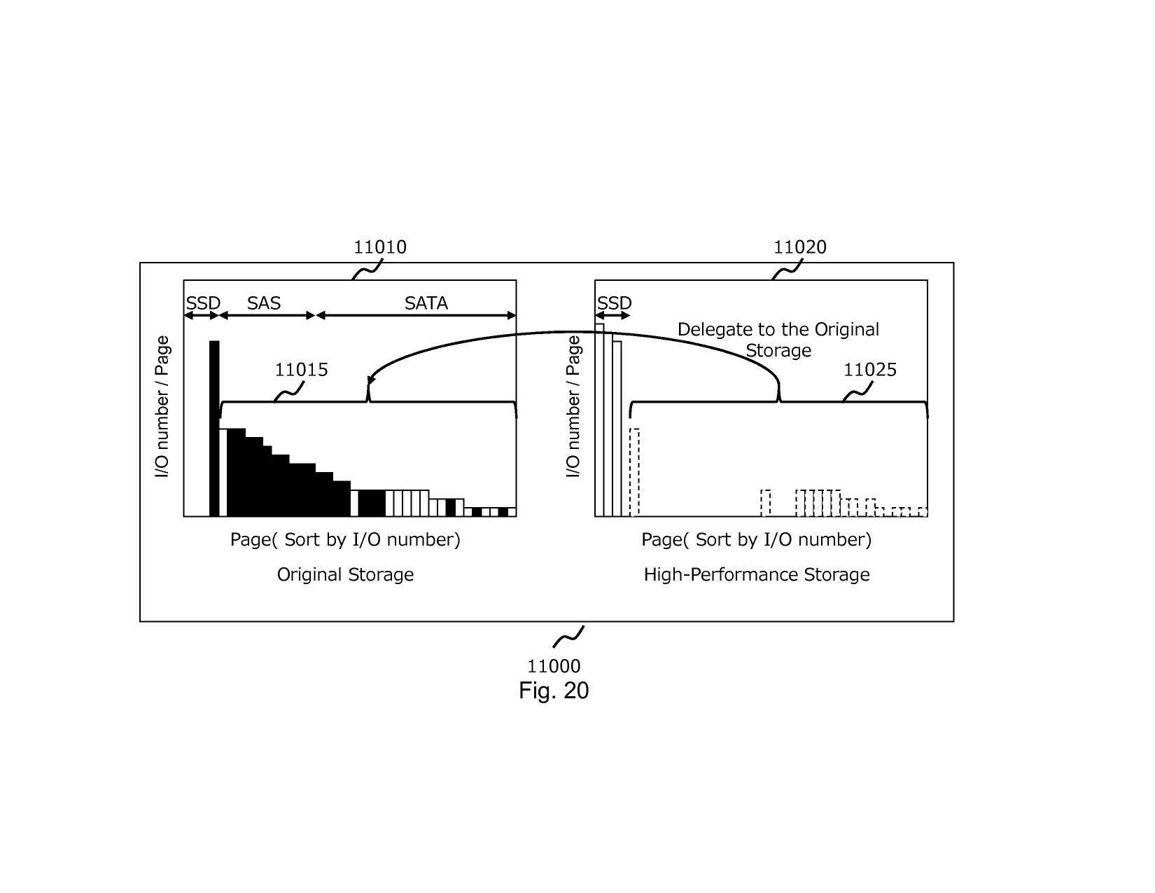

FIG. 20 illustrates the page distribution graph to evaluate the impact of partial migration in accordance with the second exemplary embodiment. FIG. 20 shows the outline of the estimation for the virtual volume VVOL_1.

The left graph 11010 illustrates the page distribution of the original storage subsystem. The right graph 11020 illustrates the page distribution of the high-performance storage subsystem. White dotted line bars 11025 illustrate data entities of the pages existing in the original storage subsystem. I/O requests directed to those pages existing in the original storage subsystem are delegated to the original storage subsystem. In the example shown in FIG. 20, 380 I/Os are delegated to the original storage subsystem. The number of I/Os can be calculated by using the right graph 11020 and the media assignment table 8001-A.

The management program 1262 can display the page distribution graph to evaluate the impact of partial migration 11000 by using input/output device 1270. The user is thereby informed of the influence if the partial migration in advance.

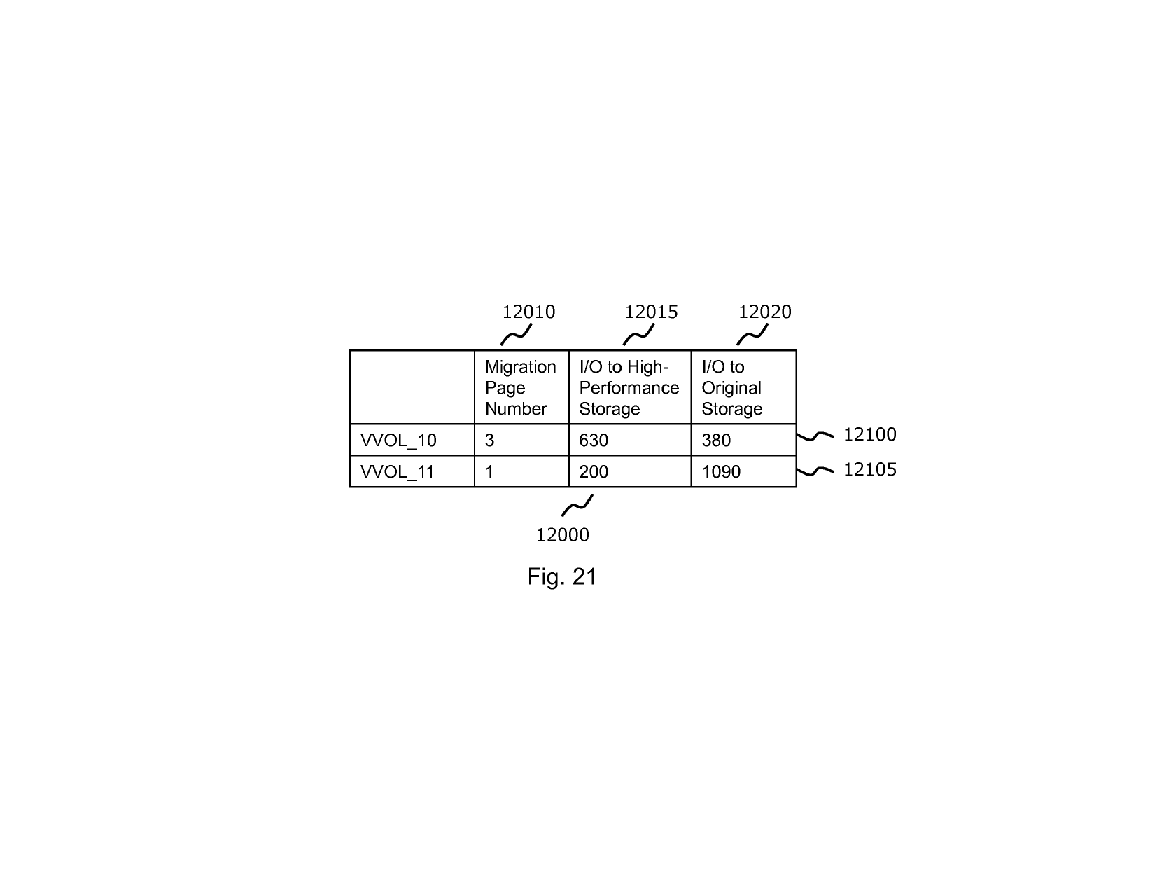

FIG. 21 illustrates a migration plan evaluation table 12000 in accordance with the second exemplary embodiment. The ‘Migration Page Number’ column 12010 indicates the page number to migrate by the partial migration. This number is created in Step 9090. The ‘I/O to High-Performance Storage’ column 12015 shows the number of I/Os directed to the high-performance storage. The ‘I/O to Original Storage’ column 12020 shows the number of I/Os delegated from the high-performance storage to the original storage.

Rows 12100 and 12105 illustrate exemplary entries. For example, row 12100 is an entry indicating that the migration page number from the original storage subsystem to the high-performance storage subsystem of VVOL_10 is 3. As a result of the migration, the number of I/Os delegated the high-performance storage subsystem of VVOL_10 is 630 and the number of I/Os delegated to the original storage subsystem of VVOL_10 is 380.

In the example shown in FIG. 21, 380 I/Os are delegated by partially migrating VVOL_10, whereas 1090 I/Os are delegated by partially migrating VVOL_11. By this estimation, management server can select VVOL_10 as a target of partial migration. By selecting a plan which minimizes the numbers of I/Os delegated to the original storage subsystem, network resource usage can be minimized.

### Third Exemplary Embodiment

The third exemplary embodiment involves a variation of step 9110 of FIG. 15. In the third exemplary embodiment, the management program 1262 selects the plan to keep the amount of migration data between storage subsystems at a minimum. The third exemplary embodiment is described with reference to the second exemplary embodiment as follows. When the migration plan evaluation table 12000 is created, the management program 1262 can reference this table and select the partial migration plan that minimizes the number of pages migrated. In the example shown on FIG. 21, virtual volume VVOL_11 is selected.

In some situations, there may be a few free high-performance media in the storage pool. In this situation, the management program 1262 may have to complete the partial migration as soon as possible due to the limited availability of high performance media. Therefore, selecting the plan where the amount of migration data between storage subsystems is kept at a minimum will provide the shortest migration time, when there are free high-performance media in the storage pool.

When one or more virtual volumes 1850 exceed the threshold, the management program 1262 creates a migration plan evaluation table 12000, displays the page distribution graph to evaluate the impact of migration 11000 and queries a user to select a target of partial migration. Alternatively, the management program 1262 can select a plan based on a preset policy. For example, a user can preset the policy to “select partial migration plan to minimize the amount of I/Os between storage subsystems” in advance. The management program 1262 can then select the plan from the candidate plans based on the preset policy.

### Fourth Exemplary Embodiment

Conducting a partial migration is not a permanent solution, but rather a temporary solution that utilizes the high-performance storage subsystem in case if the performance of some storage subsystem is insufficient in comparison to the threshold. Therefore, the partial migrated virtual volume should be returned back to the original storage subsystem in the future.

The fourth exemplary embodiment is directed to returning the partial migrated virtual volume to the original storage subsystem. The physical configuration of the system is described below with reference to the first exemplary embodiment. In the fourth exemplary embodiment, a turn back program 1264 exists in the logical disk 1260 in the management server 1200. The logical configuration of the system in the fourth exemplary embodiment is same as the configuration shown in FIG. 16. In the example of FIG. 16, virtual volume VVOL_3 has been partially migrated and this virtual volume is turned back to the storage subsystem 1400-A.

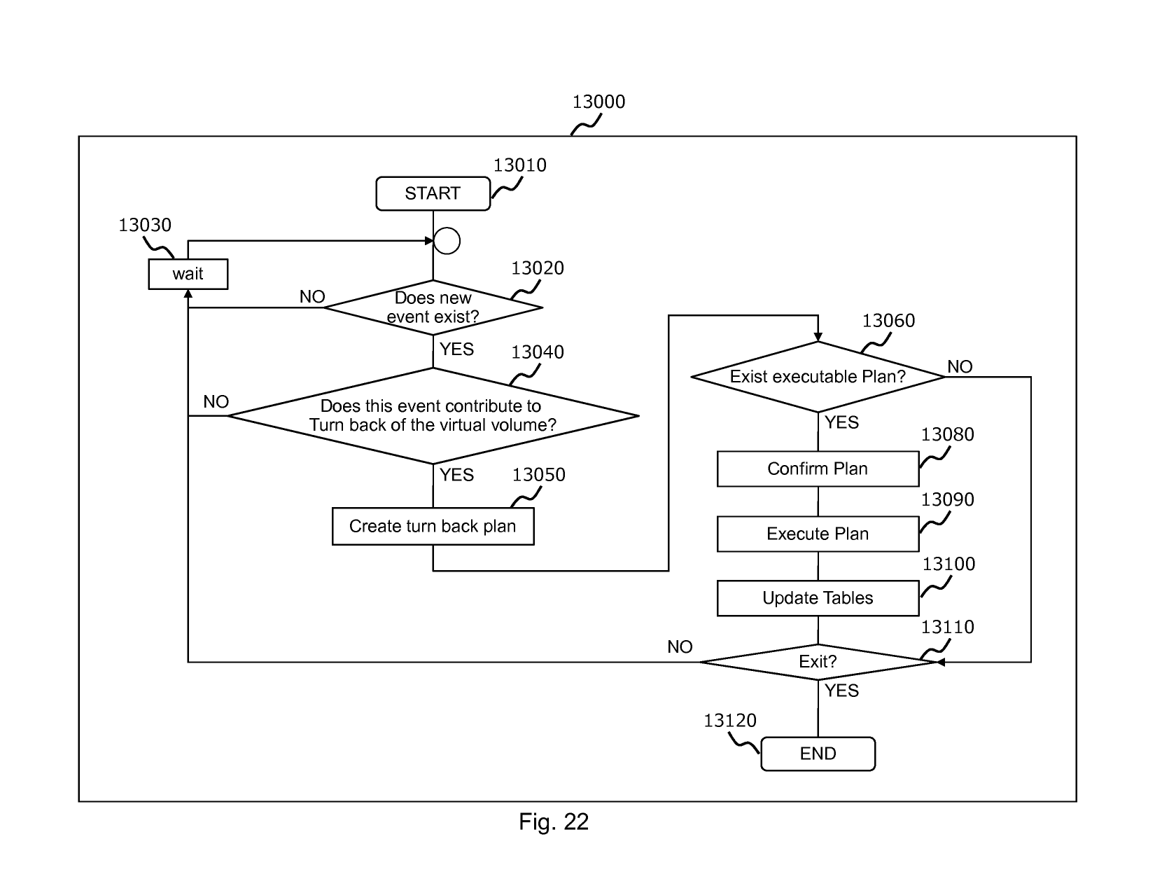

FIG. 22 illustrates an exemplary flowchart of the turn back program in the management server in accordance with the fourth exemplary embodiment. FIG. 22 illustrates the flowchart of the turn back program 1264 in the management server 1200. The procedure begins at step 13010. At step 13020, the turn back program checks whether a new event has occurred. If a new event has occurred, the turn back program proceeds to step 13040, otherwise, it proceeds to step 13030. At step 13030, the turn back program may wait for a little bit before returning back to step 13020.

At step 13040, the turn back program checks what type of new event occurred. Specifically, the turn back program will check to see if the event is directed to adding SSD media to the original storage subsystem, unprovisioning the virtual volume from the storage pool shared with the partially migrated virtual volume, or shrinking the virtual volume sharing the storage pool with the partially migrated virtual volume. If the event is one of the above types, the turn back program proceeds to Step 13050, otherwise it proceeds to step 13030.

At step 13050, the turn back program creates a turn back plan. By using the media assignment table 8000, the turn back program 1264 can estimate the response time of the partially migrated virtual volume when it is turned back to the original storage subsystem. The turn back program 1264 can estimate the response time of the partially migrated virtual volume when all of the migrated pages are turned back to the original storage subsystem. If the estimated response time is below threshold, then the plan is executable. Otherwise the plan is not executable.

At step 13060, the turn back program checks for the existence of an executable plans. If an executable plan exists, the turn back program proceeds to step 13080, otherwise the turn back program sends an error message to the user and proceeds to step 13110.

At step 13080, the turn back program provides a created plan to the user. The user can select an immediate execution of the plan or a scheduled execution. If the user opts for a scheduled execution, the plan is registered to the scheduler.

At step 13090 the plan is executed. When the execution of the plan is finished, the turn back program updates configuration information at step 13100. To update the configuration information, the turn back program obtains several tables The server configuration information table 4000-A is obtained from the monitoring program 1362 from each server 1300. The storage configuration information table 4000-B is obtained from the monitoring program 1462 from each storage subsystem 1400. The configuration information table 4000 is then updated based on the obtained tables. The pool configuration table 5000 is updated based on the configuration information table 4000.

At step 13110, the turn back program checks whether the user has provided a termination indication. If such a termination indication exists, then the turn back program proceeds to step 131200, otherwise it proceeds to step 13030.

At step 13120, the procedure for the turn back program ends. The turn back program may thereby maintain a service level after turning back the partially migrated virtual volume.

### Fifth Exemplary Embodiment

In the third exemplary embodiment as described above, the management program 1262 creates a plan to execute a partial migration of a hot spot of each virtual volume to the high-performance storage subsystem. However, there may occur situations where there isn't enough free space in the high-performance storage subsystem to execute the partial migration. Thus, the fifth exemplary embodiment provides a process for the management program 1262 if there isn't enough free space in the high-performance storage subsystem.

When the high-performance storage subsystem is already used by more than one virtual volume due to partial migration and there isn't enough free space in the high-performance storage subsystem to execute a partial migration of a virtual volume with an insufficient performance level, the management program 1262 can execute a partial migration of the virtual volume with the insufficient performance level by turning pages of the virtual volume utilizing the high-performance storage subsystem back to the original storage subsystem. The description of the fifth exemplary embodiment will be made with reference to the third exemplary embodiment.

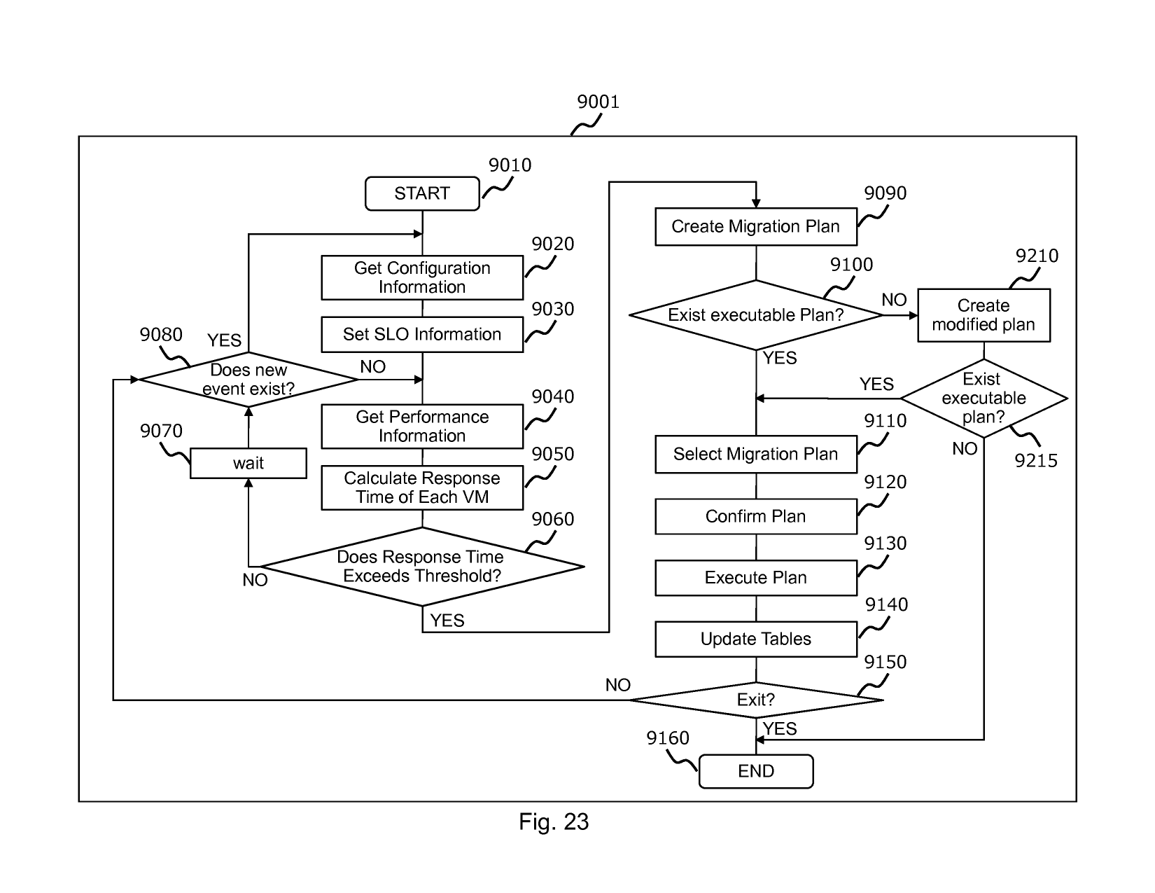

FIG. 23 illustrates an exemplary flowchart of the management program 1262 in the management server 1200 in accordance with an exemplary embodiment. The fifth exemplary embodiment deviates from the third exemplary embodiment at step 9100, step 9210 and step 9215.

At Step 9100, the management program checks whether an executable plan exists. If an executable plan exists, then the management program proceeds to step 9110, otherwise, it proceeds to step 9210.

At step 9210, the management program checks whether more than one virtual volume is already utilizing the high-performance storage subsystem. If no virtual volume is utilizing the high-performance storage subsystem, the management program proceeds to step 9215, otherwise the management program attempts to generate a plan.

For generating the plan, the management program first calculates the number of lacking pages. The management program obtains the number of pages for migration of the target virtual volume from the Migration Plan Evaluation Table 12000. The management program also obtains the unused page number of the high-performance storage subsystem from the Media Assignment Table 8000. The difference between the number of pages for migration and the unused page number is the number of the lacking pages. This number is defined herein as ‘L’.

The management program then proceeds to determine whether there is a virtual volume that satisfies several conditions. Specifically, the management program checks to see if the virtual volume is partially migrated to the high-performance storage subsystem and if the resulting response time of the virtual volume remains below the threshold when the ‘L’ pages are partially turned back from the high-performance storage subsystem to the original storage subsystem. If the aforementioned conditions are satisfied, then a valid partial migration plan is generated. The valid partial migration plan includes turning back the ‘L’ pages of the selected virtual volume from the high-performance storage subsystem to the original storage subsystem, and executing partial migration of the virtual volume with insufficient performance to the high performance storage subsystem.

At step 9215, the management program determines whether an executable plan exists. If an executable plan exists, the management program proceeds to Step 9110, otherwise, the management program notifies the user of an error message and proceeds to Step 9160.

Moreover, other implementations of the exemplary embodiments will be apparent to those skilled in the art from consideration of the specification and practice of the exemplary embodiments disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A first storage system, comprising:
a storage device; and
a controller that manages a plurality of virtual volumes and changes a status of one of the plurality of virtual volumes from a first status to a second status;
wherein the one of the plurality of virtual volumes has a higher load;
wherein the first status comprises having a plurality of Input/Output (I/O) requests to the one of the plurality of virtual volumes executed by the first storage system;
wherein the second status comprises having the plurality of I/O requests to the one of the plurality of virtual volumes executed by the first storage system, and a second storage system coupled to the first storage system.

2. The first storage system of claim 1, wherein the controller changes the status upon receipt of a request from a management server.

3. The first storage system of claim 1, wherein the second status further comprises having data partially migrated from the one of the plurality of virtual volumes to the second storage system.

4. The first storage system of claim 1, wherein the second status further comprises having write data directed to the one of the plurality of virtual volumes stored in the second storage system.

5. The first storage system of claim 1, wherein the controller changes the one of the plurality of virtual volumes from the second status to the first status after the one of the plurality of the virtual volumes is returned back to the first storage system from the second storage system.

6. The first storage system of claim 1, wherein the second status further comprises reducing a number of the plurality of I/O requests executed by the first storage system from the number of the plurality of I/O requests executed by the first storage system in the first status.

7. A method of a first storage system comprising a storage device, the method comprising:
managing a plurality of virtual volumes; and
changing a status of one of the plurality of virtual volumes from a first status to a second status;
wherein the one of the plurality of virtual volumes has a higher load;
wherein the first status comprises having a plurality of Input/Output (I/O) requests to the one of the plurality of virtual volumes executed by the first storage system;
wherein the second status comprises having the plurality of I/O requests to the one of the plurality of virtual volumes executed by the first storage system, and a second storage system coupled to the first storage system.

8. The method of claim 7, further comprising changing the status upon receipt of a request from a management server.

9. The method of claim 7, wherein the second status further comprises having data partially migrated from the one of the plurality of virtual volumes to the second storage system.

10. The method of claim 7, wherein the second status further comprises having write data directed to the one of the plurality of virtual volumes stored in the second storage system.

11. The method of claim 7, further comprising changing the one of the plurality of virtual volumes from the second status to the first status after the one of the plurality of the virtual volumes is returned back to the first storage system from the second storage system.

12. The method of claim 7, wherein the second status further comprises reducing a number of the plurality of I/O requests executed by the first storage system from the number of the plurality of I/O requests executed by the first storage system in the first status.

13. A system, comprising:
a management server;
a first storage system comprising a storage device; and a controller that manages a plurality of first virtual volumes and changes a status of one of the plurality of first virtual volumes from a first status to a second status; and
a second storage system coupled to the first storage system;
wherein the one of the plurality of first virtual volumes has a higher;
wherein the first status comprises having a plurality of Input/Output (I/O) requests to the one of the plurality of first virtual volumes executed by the first storage system;
wherein the second status comprises having the plurality of I/O requests to the one of the plurality of first virtual volumes executed by the first storage system and a second storage system coupled to the first storage system.

14. The system of claim 13, wherein the controller changes the status upon receipt of a request from the management server.

15. The system of claim 13, wherein the second status further comprises having data partially migrated from the one of the plurality of first virtual volumes to the second storage system.

16. The system of claim 13, wherein the second status further comprises having write data directed to the one of the plurality of first virtual volumes stored in the second storage system.

17. The system of claim 13, wherein the controller changes the one of the plurality of first virtual volumes from the second status to the first status after the one of the plurality of the first virtual volumes is returned back to the first storage system from the second storage system.

18. The system of claim 13, wherein the second status further comprises reducing a number of the plurality of I/O requests executed by the first storage system from the number of the plurality of I/O requests executed by the first storage system in the first status.

19. The system of claim 13, wherein the second storage system comprises a plurality of second virtual volumes, wherein each storage volume in the second storage system are mapped to the plurality of second virtual volumes.

20. The system of claim 13, wherein the management server generates a migration plan for partially migrating the one of the plurality of first virtual volumes to the second storage system based on a response time of the one of the plurality of first virtual volumes.
